(19) United States
(12) Patent Application Publication
(10) Pub. No.: US 2010/0207292 A1
(43) Pub. Date: Aug. 19, 2010

(54) PROCESS FOR PRODUCING THERMOPLASTIC RESIN FILM

(75) Inventor: Masahiko Noritsune, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/679,859

(22) PCT Filed: Jan. 20, 2008
(86) PCT No.: PCT/JP2008/066650

§ 371 Date: Mar. 24, 2010

(30) Foreign Application Priority Data
Sep. 25, 2007 (JP) 2007-247119

(51) Int. Cl. B29C 47/88

(52) U.S. Cl. 264/211.11; 264/211.12

(57) ABSTRACT

According to a process for producing a thermoplastic resin film according to one aspect of the present invention, a molten resin, while the molten resin is discharged from a die and thereafter lands onto a cooling roller, is uniformly heated in a direction of a flow by a heater. Thereby, a thermoplastic resin film having very slight thickness unevenness in a longitudinal direction can be formed. Moreover, according to the process for producing a thermoplastic resin film, heating by the heater can reduce a viscosity of the molten resin at the time of landing, and can suppress generation of retardation at the time of landing.

### TECHNICAL FIELD

The present invention relates to a process for producing a thermoplastic resin film, and particularly relates to a process for producing a thermoplastic resin film used for a liquid crystal display.

### BACKGROUND ART

Thermoplastic resin films such as cellulose acylate films are formed by melting a thermoplastic resin by an extruder, extruding the molten resin to a die, and forming the molten resin into a sheet-like resin from the die to cool and solidify the sheet-like resin. Then, an in-plane retardation (Re) and a thickness-direction retardation (Rth) are generated by stretching the thermoplastic resin film that has been subjected to this film forming step in a lengthwise (longitudinal) direction and in a transverse (width) direction, and the obtained film is used as a retardation film for a liquid crystal display element to attain a wider viewing angle (for example, see Patent Document 1).

As a process for forming a thermoplastic resin film before extension, a process for casting a sheet-like resin extruded from a die onto a cooling roller and a process for nipping a sheet-like resin by an elastic roller and a cooling roller have been known. Among these, a film forming apparatus for a touch roll method that nips a sheet-like resin by an elastic roller and a cooling roller can press a molten resin so as to form the molten resin into a plane form. Accordingly, a thermoplastic resin film with good thickness accuracy can be formed.

### Patent Document 1: National Publication of International Patent Application No. 1994-501040

### DISCLOSURE OF THE INVENTION

### Problems to be Solved by the Invention

By the way, before the molten resin discharged from the die lands onto the cooling roller, the temperature of the molten resin is reduced so that temperature distribution is easily produced. For this reason, conventionally, there has been a problem that viscosity distribution of the molten resin is produced together with the temperature distribution of the molten resin, and thickness unevenness in the thermoplastic resin film after film forming is easily produced.

Moreover, the conventional processes have had a problem as follows. For a period of time when the molten resin is discharged from the die and lands onto the cooling roller, the temperature of the molten resin decreases and the viscosity thereof increases. For this reason, when the molten resin lands on the cooling roller, retardation is produced. Particularly, in the case of the touch roll method, because the molten resin is nipped between the elastic roller and the cooling roller, there has been a problem to easily generate large retardation.

As one of the methods for solving this problem, a method for raising the temperature of the molten resin at the time of discharge from the die can be considered. However, there has been a problem that when the temperature of the molten resin at the time of discharge from the die is excessively raised, the molten resin easily sags by a self weight to become unstable, and thickness unevenness is likely to be produced.

The present invention has been made in consideration of such circumstances. An object of the present invention is to provide a process for producing a thermoplastic resin film that can form a thermoplastic resin film having higher thickness accuracy and smaller retardation.

### Means for Solving the Problems

In order to achieve the object, a first aspect according to the present invention is a process for producing a thermoplastic resin film in which a molten thermoplastic resin is discharged into a sheet-like shape from a die, landed onto a rotating cooling roller, and cooled and solidified to produce a film, characterized in that the molten resin, while the molten resin is discharged from the die and thereafter lands onto the cooling roller, is heated by a heater that can change an output in a direction of a flow of the molten resin, thereby to control temperature distribution in the direction of the flow of the molten resin within 10° C. (inclusive).

According to a first aspect, the molten resin, while the molten resin is discharged from the die and thereafter lands onto the cooling roller, is heated by the heater in the direction of the flow of the molten resin approximately uniformly (so as to have the temperature distribution within 10° C. (inclusive)). Accordingly, a thermoplastic resin film having very slight thickness unevenness in a longitudinal direction can be formed. Moreover, according to the present invention, heating by the heater can reduce a viscosity of the molten resin at the time of landing, and can suppress generation of retardation at the time of landing.

A second aspect according to the present invention is characterized in that in the first aspect, the heater can change an output in a width direction of the molten resin, and control temperature distribution in the width direction of the molten resin within 10° C. (inclusive).

According to the second aspect, a thermoplastic resin film also having very slight thickness unevenness in the width direction can be formed.

A third aspect according to the present invention is characterized in that in the first aspect or the second aspect, thickness unevenness of the thermoplastic resin film after film forming is controlled so as to be not more than 1 μm. The third aspect is particularly effective when a thermoplastic resin film with accuracy of thickness unevenness of not more than 1 μm is manufactured.

A forth aspect according to the present invention is characterized in that in one of the first aspect to the third aspect, the molten resin for a period of time when the molten resin is discharged from the die and lands onto the cooling roller has a melt viscosity of not less than 100 Pa·s and not more than 2500 Pa·s.

A fifth aspect according to the present invention is characterized in that in one of the first aspect to the forth aspect, the molten resin for a period of time when the molten resin is discharged from the die and lands onto the cooling roller has a length of not less than 100 mm and less than 900 mm in the direction of the flow of the molten resin.

A sixth aspect according to the present invention is characterized in that in one of the first aspect to the fifth aspect, the thermoplastic resin is a cellulose-based resin.

### ADVANTAGE OF THE INVENTION

According to the present invention, the molten resin, while the molten resin is discharged from the die and thereafter lands onto the cooling roller, is uniformly heated by the heater. Thereby, a thermoplastic resin film having very slight thickness unevenness can be formed. Moreover, according to the present invention, heating by the heater can reduce a viscosity of the molten resin at the time of landing, and can suppress generation of retardation at the time of landing.

### BRIEF DESCRIPTION OF THE DRAWINGS

FIG. 1 is a configuration diagram showing a configuration of a film production apparatus to which the present invention is applied;

FIG. 2 is a schematic view showing a configuration of an extruder;

FIG. 3 is a perspective view showing a film forming section;

FIG. 4 is a schematic view showing a pair of rollers made of a metal in the film forming section;

FIG. 5 is a schematic view showing a film forming section according to other embodiment; and

FIGS. 6A and 6B are tables showing results of Examples.

### DESCRIPTION OF SYMBOLS

10 . . . film production apparatus
12 . . . sheet-like resin
12′ . . . cellulose acylate film
14 . . . film forming section
20 . . . take-up section
22 . . . extruder
24 . . . die
24a . . . die lip
25 . . . heater heating unit
25a . . . heater
26 . . . roller (elastic roller)
27 . . . cover
28 . . . roller (cooling roller)
28′ . . . casting roller
44 . . . metal cylinder (external cylinder)
46 . . . fluid medium layer
48 . . . elastic body layer (internal cylinder)
50 . . . metallic shaft
Q . . . length contacting
Y . . . film forming velocity
Z . . . thickness of external cylinder

### BEST MODE FOR CARRYING OUT THE INVENTION

Hereinafter, a preferable embodiment of a process for producing a cellulose-based resin film according to the present invention will be described in accordance with the accompanying drawings. Although the present embodiment shows an example of production of a cellulose acylate film, the present invention will not be limited to such an example, and can be applied also to production of a cellulose-based resin films other than the cellulose acylate film. Moreover, in the present embodiment, description will be given about a case where a film is formed by a touch roll technique that cools a resin extruded from a die while sandwiching the resin by a pair of rollers, and a pressing roller is a metal elastic roller. However, the present invention will not be limited to this.

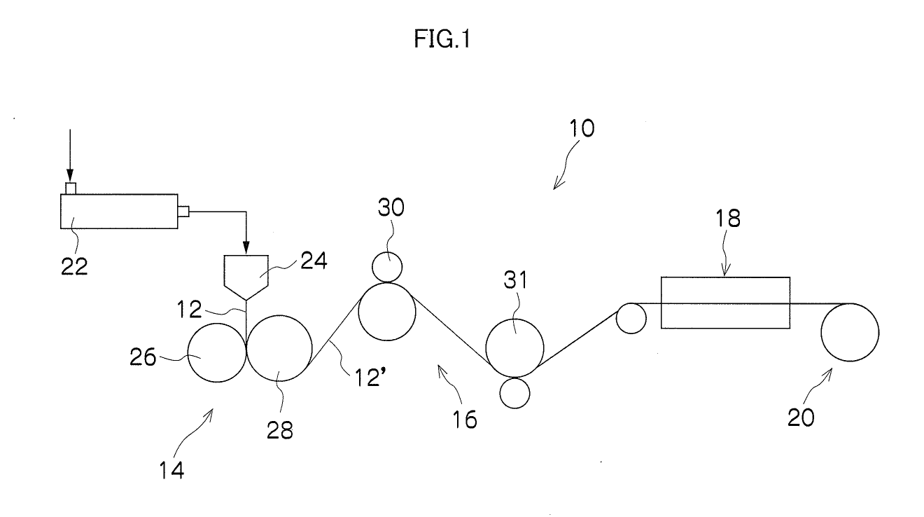

FIG. 1 shows an example of a schematic configuration of an apparatus for producing a cellulose acylate film. As shown in FIG. 1, the production apparatus 10 mainly includes a film forming section 14 that forms a cellulose acylate film 12′ before extension, a lengthwise stretching section 16 that stretches the cellulose acylate film 12′ formed in the film forming section 14 lengthwise, a transverse stretching section 18 that stretches the cellulose acylate film 12′ in a transverse direction, and a take-up section 20 that winds up the stretched cellulose acylate film 12′.

In the film forming section 14, a molten cellulose acylate resin is discharged from the die 24 into to a sheet-like form by the extruder 22, and is fed between a pair of rotating rollers 26 and 28. Then, the cellulose acylate film 12′ cooled and solidified on the roller 28 is peeled off from the roller 28. Subsequently, the cellulose acylate film 12′ is sequentially fed to the lengthwise stretching section 16 and the transverse stretching section 18 to be stretched, and taken up into a roll form in the take-up section 20. Thereby, the stretched cellulose acylate film 12′ is manufactured. Hereinafter, details of each section will be described.

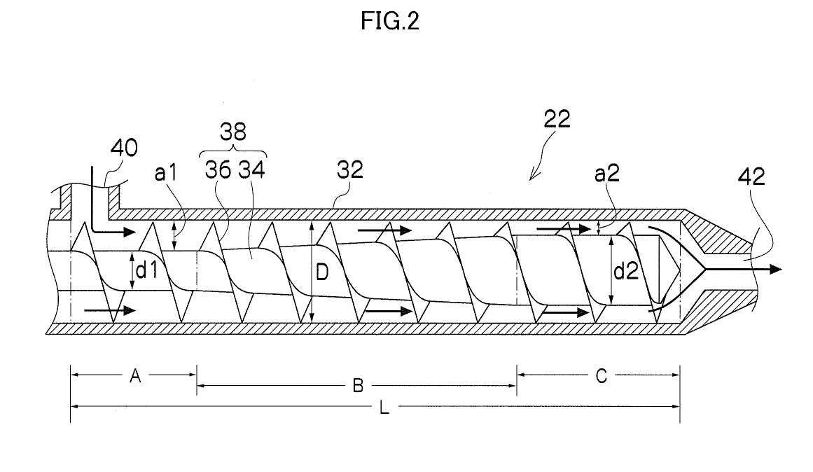

FIG. 2 shows the extruder 22 with a monoaxial screw in the film forming section 14. As shown in FIG. 2, a monoaxial screw 38 having a flight 36 in a screw shaft 34 is arranged within a cylinder 32. The cellulose acylate resin is fed into the cylinder 32 through a feed opening 40 from a hopper not shown. From the feed opening 40 side in order, an inside of the cylinder 32 is formed of a feed section (region shown by A) for conveying a fixed amount of the cellulose acylate resin fed from the feed opening 40, a compression section (region shown by B) for kneading and compressing the cellulose acylate resin, and a measuring section for measuring the cellulose acylate resin kneaded and compressed (region shown by C). By the extruder 22, the molten cellulose acylate resin is continuously fed into the die 24 from a discharge opening 42.

A screw compression ratio of the extruder 22 is set at 2.5 to 4.5, and an L/D is set at 20 to 50. Here, the screw compression ratio is a volume ratio of the feed section A and the measuring section C, and in other words, is expressed by a volume per unit length of the feed section A/a volume per unit length of the measuring section C. The screw compression ratio is calculated by using an outer diameter d1 of the screw shaft 34 in the feed section A, an outer diameter d2 of the screw shaft 34 in the measuring section C, a diameter a1 of a slot in the feed section A, and a diameter a2 of a slot in the measuring section C. Moreover, the L/D is a ratio of a cylinder length (L) to a cylinder inner diameter (D) in FIG. 2. An extrusion temperature is set at 190 to 240° C. When the temperature within the extruder 22 exceeds 240° C., a cooler (not shown) may be provided between the extruder 22 and the die 24.

The extruder 22 may be a monoaxial extruder or a biaxial extruder. However, when the screw compression ratio is less than 2.5 and too small, kneading is insufficient so that an undissolved portion is produced, and small shear heating makes dissolution of a crystal insufficient. Fine crystals are likely to remain in the cellulose acylate film after production, and further bubbles are likely to be mixed. Thereby, when the cellulose acylate film 12′ is stretched, the remaining crystals obstruct stretchability and make it impossible to sufficiently increase orientation. On the other hand, when the screw compression ratio exceeds 4.5 and is too large, an excessive shear stress is applied so that the resin easily deteriorates by generation of heat. For that reason, yellowness is likely to be caused in the cellulose acylate film after production. Moreover, when an excessive shear stress is applied, a molecule is cut so that a molecular weight is reduced. Thereby, mechanical strength of the film is reduced. Accordingly, in order to make it unlikely to cause yellowness in the cellulose acylate film after production and extension breakage, the screw compression ratio is preferably within the range of not less than 2.5 and not more than 4.5, more preferably within the range of not less than 2.8 and not more than 4.2, and particularly preferably within the range of not less than 3.0 and not more than 4.0.

Moreover, when the L/D is less than 20 and too small, insufficient molten and insufficient kneading occur. Fine crystals are likely to remain in the cellulose acylate film after production similarly to the case where the compression ratio is small. On the other hand, when the L/D exceeds 50 and is too large, residence time of the cellulose acylate resin within the extruder 22 becomes too long, and the resin easily deteriorates. Moreover, when the residence time becomes longer, a molecule is cut so that a molecular weight is reduced. Thereby, mechanical strength of the film is reduced. Accordingly, in order to make it unlikely to cause yellowness in the cellulose acylate film after production and extension breakage, the L/D is preferably within the range of not less than 20 and not more than 50, more preferably within the range of not less than 22 and not more than 45, and particularly preferably within the range of not less than 24 and not more than 40.

Moreover, when the extrusion temperature is less than 190° C. and too low, dissolving of the crystals becomes insufficient, and fine crystals easily remain in the cellulose acylate film after production. Thereby, when the cellulose acylate film is stretched, the remaining crystals obstruct stretchability and make it impossible to sufficiently increase orientation. On the other hand, when the extrusion temperature exceeds 240° C. and is too high, the cellulose acylate resin deteriorates and a degree of yellowness (Y1 value) deteriorates. Accordingly, in order to make it unlikely to cause yellowness in the cellulose acylate film after production and extension breakage, the extrusion temperature is preferably within the range of not less than 190° C. and not more than 240° C., more preferably within the range of not less than 195° C. and not more than 235° C., and particularly preferably within the range of not less than 200° C. and not more than 230° C.

Using the extruder 22 thus configured, the cellulose acylate resin is molted, and the molten resin is continuously fed into the die 24, and discharged into a sheet-like form from an end (lower end) of the die 24. Then, the discharged sheet-like resin 12 is fed between the elastic roller 26 and the cooling roller 28 (see FIG. 1).

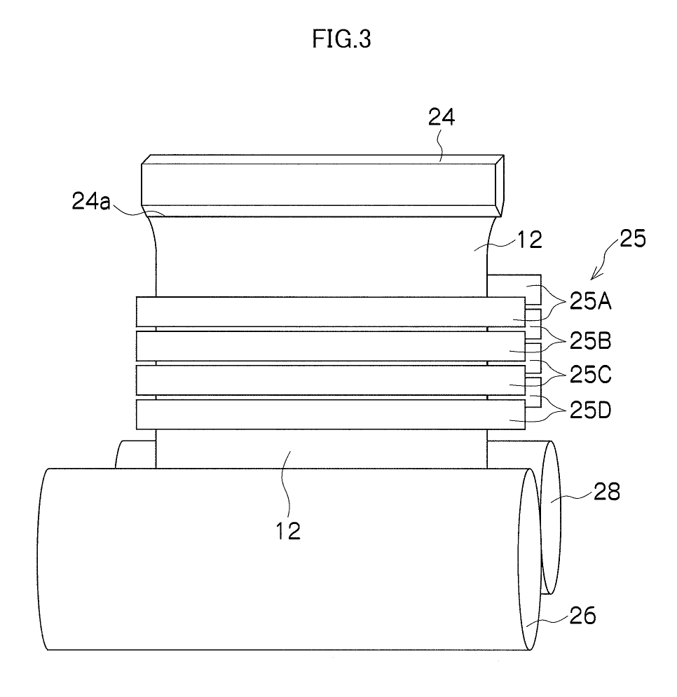

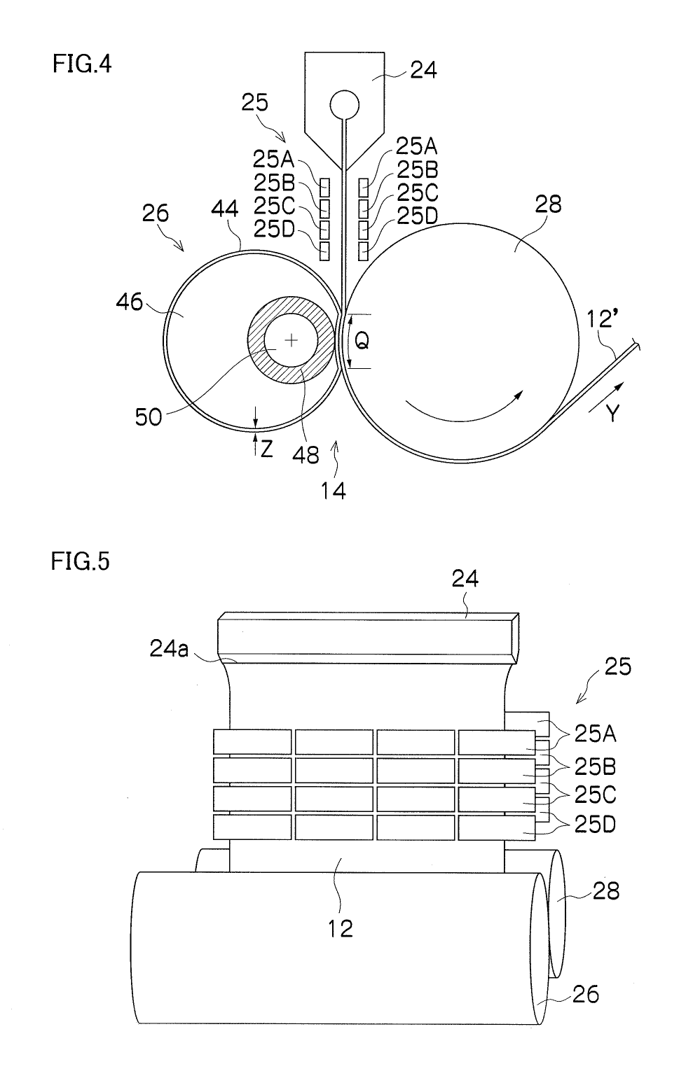

FIG. 3 and FIG. 4 show one embodiment according to the present invention.

The elastic roller 26 and the cooling roller 28 have a surface of a mirror finished surface or close to a mirror finished surface, and are mirror-finished so as to have an arithmetic mean height Ra of not more than 100 nm, preferably not more than 50 nm, and more preferably not more than 25 nm. The elastic roller 26 and the cooling roller 28 are also configured so as to be able to control the surface temperature thereof. For example, the surface temperature can be controlled by circulating a fluid medium such as water within the elastic roller 26 and the cooling roller 28. Moreover, of the elastic roller 26 and the cooling roller 28, the elastic roller 26 is formed so as to have a diameter smaller than that of the other cooling roller 28. The surface of the elastic roller 26 is made of a metallic material so that the surface temperature can be controlled with sufficient accuracy. Additionally, the elastic roller 26 and the cooling roller 28 rotate at the same surface velocity.

Moreover, as shown in FIG. 3 and FIG. 4, the heater heating unit 25 is provided between the die 24 and the elastic roller 26 and the cooling roller 28. The heater heating unit 25 includes a plurality of heaters 25A to 25D arranged in a lengthwise direction (namely, the direction of a flow of the sheet-like resin 12 (MD)) on both sides of the sheet-like resin 12. Each of the heaters 25A to 25D is formed so as to have a width larger than that of the die 24, and can heat the sheet-like resin 12 securely. Preferably, the width of each of the heaters 25A to 25D is 1.0 time that of the lip 24a of the die 24. More preferably, the width of each of the heaters 25A to 25D is 1.2 times that of the lip 24a of the die 24 as a lower limit and has the same length as the roller length of the cooling roller 28 as an upper limit.

Each of the heaters 25A to 25D is also configured so as to be able to control an output separately. Thereby, the output is controlled so that the temperature distribution in the direction of the flow of the sheet-like resin 12 heated by each of the heaters 25A to 25D is not more than 10° C. Thereby, a factor that causes thickness unevenness at the time of film forming can be reduced, and the cellulose acylate film 12′ having uniform thickness can be obtained. The temperature distribution in the direction of the flow of the sheet-like resin 12 is more preferably not more than 5° C., and more preferably not more than 1° C.

Moreover, preferably, the sheet-like resin 12 for a period when the sheet-like resin 12 is discharged from the die 24 and lands onto the cooling roller 28 has a viscosity of not less than 100 Pa·s and not more than 2500 Pa·s. When the viscosity of the sheet-like resin 12 is out of the above-mentioned range, stability of the sheet-like resin 12 is reduced, which leads to a factor that causes step unevenness and the like.

Moreover, preferably, a length F in the direction of the flow of the sheet-like resin 12 is not less than 100 mm and less than 900 mm. When the length of the sheet-like resin 12 exceeds the above-mentioned range, stable temperature control of the sheet-like resin 12 becomes difficult. When the length of the sheet-like resin 12 is less than the above-mentioned range, installation of each of the heaters 25A to 25D becomes difficult.

FIG. 4 shows one embodiment of the elastic roller 26 and the cooling roller 28. The elastic roller 26 is formed of a metal cylinder (external cylinder) 44 that forms an outer shell, a fluid medium layer 46, an elastic body layer (internal cylinder) 48, and a metal shaft 50 in order from an outer layer of the elastic roller 26. The external cylinder 44 and the internal cylinder 48 of the elastic roller 26 rotate by rotation of the cooling roller 28 contacting the elastic roller 26 through the sheet-like molten resin. Thereby, when the sheet-like molten resin is sandwiched between the elastic roller 26 and the cooling roller 28, the elastic roller 26 receives a reaction force from the cooling roller 28 through the sheet, and elastically deforms into a depressed form so as to follow the surface of the cooling roller 28. Accordingly, the elastic roller 26 and the cooling roller 28 are in surface-contact with the sheet. Simultaneously, the sandwiched sheet is cooled by the cooling roller 28 while being pressed into a plane form by the restoring force that restores the shape of the elastic roller 26 elastically deformed. The metal cylinder 44 is made of a metal thin layer, and preferably has a seamless structure without a welding joint portion. Moreover, a thickness Z of the metal cylinder 44 is preferably within the range of 0.05 mm<Z<7.0 mm. Here, when the thickness Z of the external cylinder of the elastic roller is not more than 0.05 mm, the restoring force is small and a surface condition improvement effect is not obtained, and further roller strength is reduced. Moreover, when the thickness Z is not less than 7.0 mm, no elasticity is obtained so that no effect of eliminating residual distortion appears. Although the thickness Z of the metal cylinder 44 may satisfy 0.05 mm<Z<7.0 mm, more preferably the thickness Z is 0.2 mm<Z<5.0 mm.

Moreover, when a glass temperature of the cellulose acylate resin is Tg (° C.), a temperature (° C.) of the elastic roller 26 is X (° C.), and a film forming velocity is Y (m/min.), preferably, the film forming velocity Y and the temperature of the elastic roller 26 are set so that (0.0043X²+0.12X+1.1)<Y<(0.019X²+0.73X+24) may be satisfied. When the film forming velocity Y is too small, time to press is too long, and residual distortion appears on the film. When the film forming velocity Y is too large, cooling time is too short to cool the film, and the film might sticks to the elastic roller 26. The temperature of the cooling roller 28 is preferably within ±20° C. (inclusive) of the temperature of the elastic roller 26, and more preferably within ±15° C. (inclusive), and still more preferably within ±10° C. (inclusive).

Further, when Q (cm) is a length of the elastic roller 26 and the cooling roller 28 contacting through the sheet-like cellulose acylate resin, and P (kg/cm) is a linear pressure at which the sheet-like cellulose acylate resin is sandwiched between the elastic roller 26 and the cooling roller 28, preferably, the linear pressure P and the contacting length Q satisfy 3 kg/cm²<P/Q<50 kg/cm². Here, when P/Q is not more than 3 kg/cm², a pressing force that presses the resin so as to have a plane state is too small, and there is no surface state improvement effect. When P/Q is not less than 50 kg/cm², the pressing force is too large, residual distortion of the film is produced and retardation is generated.

According to the film forming section 14 thus configured, by discharging the cellulose acylate resin from the die 24, the discharged cellulose acylate resin forms a very small liquid reservoir (bank) between the elastic roller 26 and the cooling roller 28. Then, the cellulose acylate resin is pressed between the elastic roller 26 and the cooling roller 28, and formed into a sheet-like form while the thickness is adjusted. At that time, the elastic roller 26 receives the reaction force from the cooling roller 28 through the cellulose acylate resin, and elastically deforms into a depressed form so as to follow the surface of the cooling roller 28. The cellulose acylate resin is pressed into a plane form by the elastic roller 26 and the cooling roller 28. Then, when the film 12′ is pressed and formed by the elastic roller 26 and the cooling roller 28 that satisfy the thickness Z of the external cylinder, the temperature, the linear pressure, and the cooling length of time, which satisfy the conditions mentioned above, it is possible to manufacture the cellulose acylate film 12′ that has no stripe failure, has high thickness accuracy, suppressed residual distortion, and small retardation, and is suitable for an optical film. Moreover, according to the film forming section 14 thus configured, it is possible to manufacture the cellulose acylate film 12′ having a film thickness of 20 to 300 μm, the in-plane retardation Re of not more than 20 nm, and the thickness-direction retardation Rth of not more than 20 nm.

Here, the retardations Re and Rth are determined by the following formulas.

Re(nm)=|n(MD)−n(TD)|×T(nm)

Rth(nm)=|{(n(MD)+n(TD))/2}−n(TH)|×T(nm)

wherein n(MD), n(TD), and n(TH) respectively designate a refractive index in the longitudinal (flow) direction, that in the width direction, and that in the thickness direction, and T designates a thickness expressed in nm.

The film 12′ pressed between the elastic roller 26 and the cooling roller 28 is taken up around the metal cooling roller 28, and cooled. Subsequently, the film 12′ is peeled off from the surface of the cooling roller 28, and is fed to the lengthwise stretching section 16 at a rear stage.

According to the method for producing the cellulose-based resin film according to the present embodiment described above, a lower part of the sheet-like resin 12 is heated using the heater heating unit 25, and the temperature distribution in the direction of the flow of the sheet-like resin 12 is controlled so as to be not more than 10° C. in the vicinity of an outlet of the die 24. Accordingly, the cellulose acylate film 12′ having a uniform thickness can be obtained.

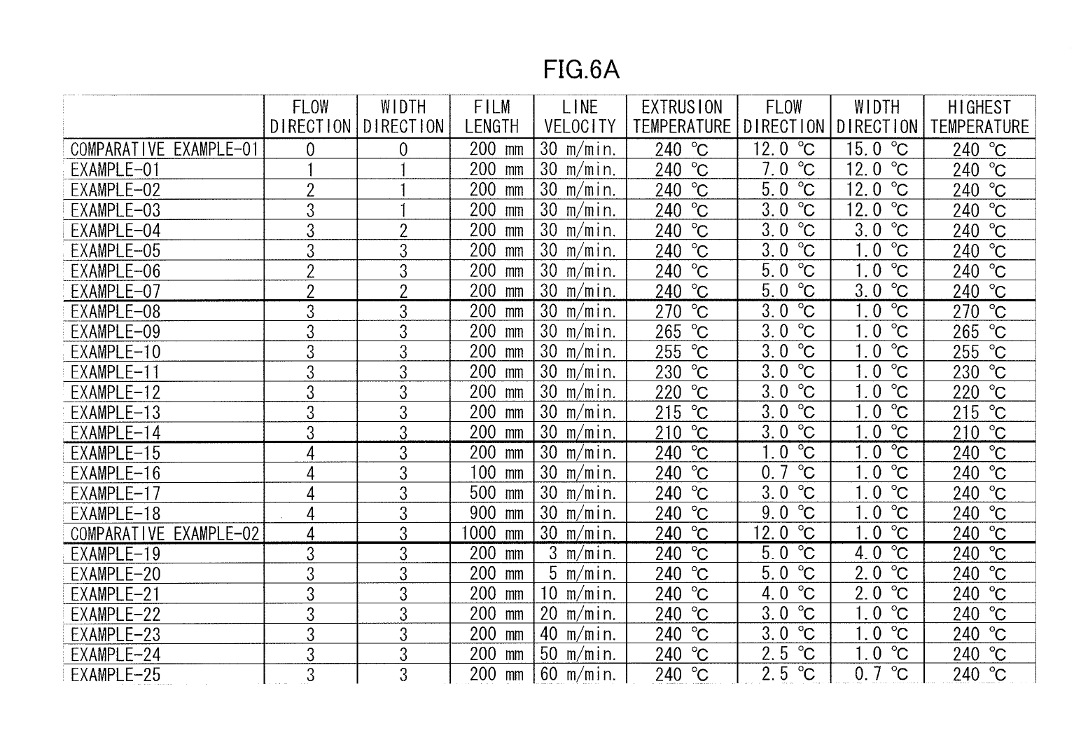

While the heater heating unit 25 that can change the output only in the direction of the flow of the sheet-like resin 12 is provided in the present embodiment mentioned above, the heater heating unit 25 that can change the output also in the width direction of the sheet-like resin 12 may be provided. FIG. 5 shows an example in which each of the heaters 25A to 25D in FIG. 3 is divided into four in the width direction of the sheet-like resin 12. The temperature of each of the divided heaters 25A to 25D can be controlled separately. Therefore, in the present embodiment, temperature control of the sheet-like resin 12 can be performed not only in the direction of the flow of the sheet-like resin 12 but also in the width direction thereof. Accordingly, the temperature distribution of the sheet-like resin 12 can be further controlled, and the cellulose acylate film 12′ having uniform thickness distribution also in the width direction can be obtained.

In the present embodiment mentioned above, the sheet-like resin 12 and the heater heating unit 25 may be covered with a cover (not shown) having a heat insulation function and/or heat reflection function. Thereby, the temperature distribution of the sheet-like resin 12 can be controlled more effectively.

While an example of the touch roll technique that cools the sheet-like resin 12 while the sheet-like resin 12 is sandwiched by the pair of rollers is shown in the present embodiment mentioned above, the present invention can also be applied to the case where the film is formed by a casting drum technique in which the sheet-like resin 12 is landed onto one roller and cooled.

Furthermore, in the present embodiment mentioned above, the heater heating unit 25 is disposed on both sides of the sheet-like resin 12. However, the present invention will not be limited to this, and the heater heating unit 25 may be disposed only on one side.

Hereinafter, description will be given of a stretching step in which the cellulose acylate film 12′ manufactured in the film forming section 14 is stretched to manufacture the stretched cellulose acylate film 12′.

The cellulose acylate film before extension is used as a protective film for a liquid crystal display element, and the film of the present invention that can control generation of retardation is particularly useful as such a protective film.

Extension of the cellulose acylate film 12′ is performed for orientation of the molecules in the cellulose acylate film 12′ and generation of the in-plane retardation (Re) and the thickness-direction retardation (Rth).

As shown in FIG. 1, first, the cellulose acylate film 12′ is stretched lengthwise in the longitudinal direction in the lengthwise stretching section 16. In the lengthwise stretching section 16, the cellulose acylate film 12′ is preheated, and subsequently is taken up around two nip rollers 30 and 31 in the state where the cellulose acylate film 12′ is heated. The nip roller 31 on an outlet side conveys the cellulose acylate film 12′ at a conveying velocity earlier than that of the nip roller 30 on an inlet side. Thus, the cellulose acylate film 12′ is stretched lengthwise.

A preheat temperature in the lengthwise stretching section 16 is preferably not less than Tg−40° C. and not more than Tg+0° C., more preferably not less than Tg−20° C. and not more than Tg+40° C., and still more preferably not less than Tg and not more than Tg+30° C. Moreover, an extension temperature in the lengthwise stretching section 16 is preferably not less than Tg and not more than Tg+60° C., more preferably not less than Tg+2° C. and not more than Tg+40° C., and still more preferably not less than Tg+5° C. and not more than Tg+30° C. A stretch ratio in the lengthwise direction is preferably not less than 1.0 time and not more than 2.5 times, and more preferably not less than 1.1 times and not more than twice.

The cellulose acylate film 12′ stretched lengthwise is fed to the transverse stretching section 18, and stretched transversely in the width direction. In the transverse stretching section 18, a tenter can be suitably used. By this tenter, both ends in the width direction of the cellulose acylate film 12′ are held with a clip, and stretched in the transverse direction. By this transverse extension, the retardation Rth can be further increased.

It is preferable that transverse extension is performed using the tenter. A preferable extension temperature is preferably not less than Tg and not more than Tg+60° C., more preferably not less than Tg+2° C. and not more than Tg+40° C., and still more preferably not less than Tg+4° C. and not more than Tg+30° C. The stretch ratio is preferably not less than 1.0 time and not more than 2.5 times, and more preferably not less than 1.1 times and not more than 2.0 times. It is also preferable that after transverse extension, the cellulose acylate film 12′ is relieved in the lengthwise or transverse direction, or in the both directions. Thereby, distribution of a slow axis in the width direction can be made small.

By such extension, Re is not less than 0 nm and not more than 500 nm, more preferably not less than 10 nm and not more than 400 nm, still more preferably not less than 15 nm and not more than 300 nm. Rth is not less than 0 nm and not more than 500 nm, more preferably not less than 50 nm and not more than 400 nm, and still more preferably not less than 70 nm and not more than 350 nm.

Among these, Re and Rth satisfying Re≦Rth is more preferable, and still more preferably, Re and Rth satisfying Re×2≦Rth is still more preferable. In order to attain such higher Rth and lower Re, preferably, the film 12′ stretched lengthwise as mentioned above is stretched in the transverse (width) direction. In other words, a difference between orientation in the lengthwise direction and that in the transverse direction is the in-plane retardation difference (Re). By extension in the lengthwise direction and in the transverse direction, which is a direction perpendicular to the lengthwise direction, the difference between orientation in the lengthwise direction and that in the transverse direction can be made small, and the plane orientation (Re) can be made small. On the other hand, extension in the lengthwise direction and the transverse direction increases area magnification. For that reason, orientation in the thickness direction is increased with reduction in the thickness, and Rth can be increased.

Further, it is preferable that each fluctuation of Re and Rth according to a place in the width direction and the longitudinal direction is not more than 5%, more preferably not more than 4%, and still more preferably not more than 3%.

The cellulose acylate film 12′ after extension is taken up into a roll form in the take-up section 20 in FIG. 1. At that time, a take-up tension of the cellulose acylate film 12′ is preferably not more than 0.02 kg/mm². By setting the take-up tension in such a range, the stretched cellulose acylate film 12′ can be taken up without producing retardation distribution in the stretched cellulose acylate film 12′.

Hereinafter, a cellulose acylate resin, a method for processing a cellulose acylate film, and the like suitable for the present invention will be described in detail along with a procedure.

### (1) Plasticizer

Preferably, a polyhydric alcohol based plasticizer is added to a resin for producing the cellulose acylate film in the present invention. Such a plasticizer reduces the elastic modulus, and also has an effect of reducing a difference between the amount of crystals in the front surface and that in the rear surface.

A content of the polyhydric-alcohol based plasticizer is preferably 2 to 20 weight % to cellulose acylate. The content of the polyhydric alcohol based plasticizer is preferably 2 to 20 weight %, more preferably 3 to 18 weight %, and still more preferably 4 to 15 weight %.

When the content of the polyhydric alcohol based plasticizer is less than 2 weight %, the above-mentioned effect is not achieved sufficiently. On the other hand, when the content of the polyhydric alcohol based plasticizer is more than 20 weight %, bleeding (deposition of the plasticizer on the surface) is produced.

The polyhydric alcohol based plasticizers that can be used in the present invention specifically include: glycerin based ester compounds such as glycerol ester and diglycerol ester that have excellent compatibility with cellulose fatty acid ester and show a remarkable thermo-plasticizing effect; polyalkylene glycols such as polyethylene glycol, polypropylene glycol, etc.; and compounds in which an acyl group is bonded to a hydroxyl group of polyalkylene glycol, etc.

Specifically, glycerol esters include, but are not limited to, glycerol diacetate stearate, glycerol diacetate palmitate, glycerol diacetate myristate, glycerol diacetate laurate, glycerol diacetate caprate, glycerol diacetate nonanoate, glycerol diacetate octanoate, glycerol diacetate heptanoate, glycerol diacetate hexanoate, glycerol diacetate pentanoate, glycerol diacetate olate, glycerol acetate dicaprate, glycerol acetate dinonanoate, glycerol acetate dioctanoate, glycerol acetate diheptanoate, glycerol acetate dicaproate, glycerol acetate divalerate, glycerol acetate dibutylate, glycerol dipropionate caprate, glycerol dipropionate laurate, glycerol dipropionate myristate, glycerol dipropionate palmitate, glycerol dipropionate stearate, glycerol dipropionate oleate, glycerol tributylate, glycerol tripentanoate, glycerol monopalmitate, glycerol monostearate, glycerol distearate, glycerol propionate laurate, glycerol oleate propionate, etc. These can be used alone or in combination.

Among these, glycerol diacetate caprylate, glycerol diacetate pelargonate, glycerol diacetate caprate, glycerol diacetate laurate, glycerol diacetate myristate, glycerol diacetate palmitate, glycerol diacetate stearate, and glycerol diacetate oleate are preferable.

Specific examples of diglycerol esters include, but are not limited to, mixed acid esters of diglycerol such as diglycerol tetraacetate, diglycerol tetrapropionate, diglycerol tetrabutyrate, diglycerol tetravalerate, diglycerol tetrahexanoate, diglycerol tetraheptanoate, diglycerol tetracaprylate, diglycerol tetrapelargonate, diglycerol tetracaprate, diglycerol tetralaurate, diglycerol tetramyristate, diglycerol tetrapalmitate, diglycerol triacetate propionate, diglycerol triacetate butyrate, diglycerol triacetate valerate, diglycerol triacetate hexanoate, diglycerol triacetate heptanoate, diglycerol triacetate caprylate, diglycerol triacetate pelargonate, diglycerol triacetate caprate, diglycerol triacetate laurate, diglycerol triacetate myristate, diglycerol triacetate palmitate, diglycerol triacetate stearate, diglycerol triacetate oleate, diglycerol diacetate dipropionate, diglycerol diacetate dibutylate, diglycerol diacetate divalerate, diglycerol diacetate dihexanoate, diglycerol diacetate diheptanoate, diglycerol diacetate dicaprylate, diglycerol diacetate dipelargonate, diglycerol diacetate dicaprate, diglycerol diacetate dilaurate, diglycerol diacetate dimyristate, diglycerol diacetate dipalmitate, diglycerol diacetate distearate, diglycerol diacetate diolate, diglycerol acetate tripropionate, diglycerol acetate tributylate, diglycerol acetate trivalerate, diglycerol acetate trihexanoate, diglycerol acetate triheptanoate, diglycerol acetate tricaprylate, diglycerol acetate tripelargonate, diglycerol acetate tricaprate, diglycerol acetate trilaurate, diglycerol acetate trimyristate, diglycerol acetate tripalmitate, diglycerol acetate tristearate, diglycerol acetate trioleate, diglycerol laurate, diglycerol stearate, diglycerol caprylate, diglycerol myristate, diglycerol oleate, etc. These can be used alone or in combination.

Among these, diglycerol tetraacetate, diglycerol tetrapropionate, diglycerol tetrabutyrate, diglycerol tetracaprylate, and diglycerol tetralaurate are preferable.

Specific examples of polyalkylene glycol include, but are not limited to, polyethylene glycol, polypropylene glycol having an average molecular weight of 200 to 1000. These can be used alone or in combination.

Specific examples of the compounds in which an acyl group is bonded to a hydroxyl group of polyalkylene glycol include, but are not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, polyoxypropylene linoleate, etc. These can be used alone or in combination.

Further, in order to sufficiently generate the above-mentioned effect of these polyhydric alcohols, preferably, cellulose acylate is molten to produce a film on the following conditions. In other words, a pellet made of a mixture of cellulose acylate and a polyhydric alcohol is molten by the extruder, and extruded from a T die to produce the film. At this time, preferably, an extruder outlet temperature (T2) is higher than an extruder inlet temperature (T1), and still more preferably, a die temperature (T3) is higher than T2. Namely, preferably, the temperature is increased as melting progresses. This is because the polyhydric alcohol first dissolves and is liquefied when the temperature is drastically raised from the inlet. Cellulose acylate becomes floating in the liquefied polyhydric alcohol, and cannot receive a sufficient shearing force from the screw. As a result, an undissolved object is produced. Such a material not mixed sufficiently cannot demonstrate the above-mentioned effect of the plasticizer, and the effect of controlling the difference between the front surface and the rear surface of the melt film after melting extruding is not obtained. Further, such a dissolution defective object turns into a fish eye-like foreign substance after the film forming step. Such a foreign substance is not recognized as a bright spot in observation by a polarizing plate, and can be recognized visually rather by projecting light from the rear of the film and observing on a screen. The fish eye causes tailing at a die outlet, and also increases a die line.

T1 is preferably 150 to 200° C., more preferably 160 to 195°, and still more preferably not less than 165° C. and not more than 190° C. T2 is preferably within the range of 190 to 240° C., more preferably 200 to 230° C., and still more preferably 200 to 225° C. It is important that such melting temperatures T1 and T2 are not more than 240° C. When the melting temperatures T1 and T2 exceed the above-mentioned temperature, an elastic modulus of the formed film is likely to be increased. This is because that it seems that cellulose acylate is decomposed for melting at a high temperature, thereby to cause crosslinking and increase the elastic modulus. The die temperature T3 is preferably less than 200 to 235° C., more preferably 205 to 230° C., and still more preferably not less than 205° C. and not more than 225° C.

### (2) Stabilizer

Preferably, a phosphite based compound, a phosphorous acid ester based compound, or both are used as a stabilizer in the present invention. Thereby, deterioration over time can be suppressed, and in addition, the die line can be also improved. This is because these compounds act as a leveling agent and eliminate the die line formed due to projections and depressions of the die.

A mixing amount of these stabilizers are 0.005 to 0.5 weight %, more preferably 0.01 to 0.4 weight %, and still more preferably 0.02 to 0.3 weight %.

### (1) Phosphite Based Stabilizer

Although a specific phosphite based color inhibitor is not limited in particular, a phosphite based color inhibitor expressed by the following chemical formulas (general formulas) (1) to (3) is preferable.

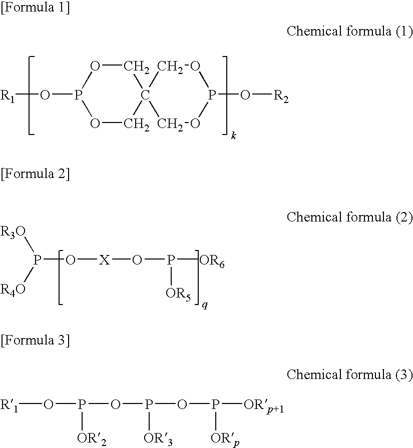

(wherein R1, R2, R3, R4, R5, R6, R′1, R′2, and R′3 . . . R′n and R′n+1 designate hydrogen or a group selected from the group consisting of alkyl of carbon atoms 4 to 23, aryl, alkoxyalkyl, aryloxyalkyl, alkoxyaryl, arylalkyl, alkylaryl, polyaryloxyalkyl, polyalkoxyalkyl, and polyalkoxyaryl group. However, not all are hydrogen in the same equation of each general formula (1), (2), or (3). X in the phosphite based color inhibitor expressed by the general formula (2) designates a group selected from the group consisting of an aliphatic series chain, an aliphatic series chain having an aromatic nucleus in a side chain, a aliphatic series chain having an aromatic nucleus in a chain, and a chain including two or less oxygen atoms continuing in the above-mentioned chains. Moreover, k and q designate an integer of not less than 1, and p designates an integer of not less than 3.)

The number of k and q in these phosphite based color inhibitors is preferably 1 to 10. It is preferable because volatility at the time of heating becomes smaller when the number of k and q is not less than 1, and compatibility with cellulose acetate propionate is improved when the number of k and q is not more than 10. Moreover, a value of p is preferably 3 to 10. It is preferable because volatility at the time of heating becomes smaller when the value of p is not less than 3, and compatibility with cellulose acetate propionate is improved when the value of p is not more than 10.

As a specific example of a phosphite based color inhibitor expressed by the following chemical formula (general formula) (4), the phosphite based color inhibitor expressed by the following chemical formulas (5) to (8) is preferable.

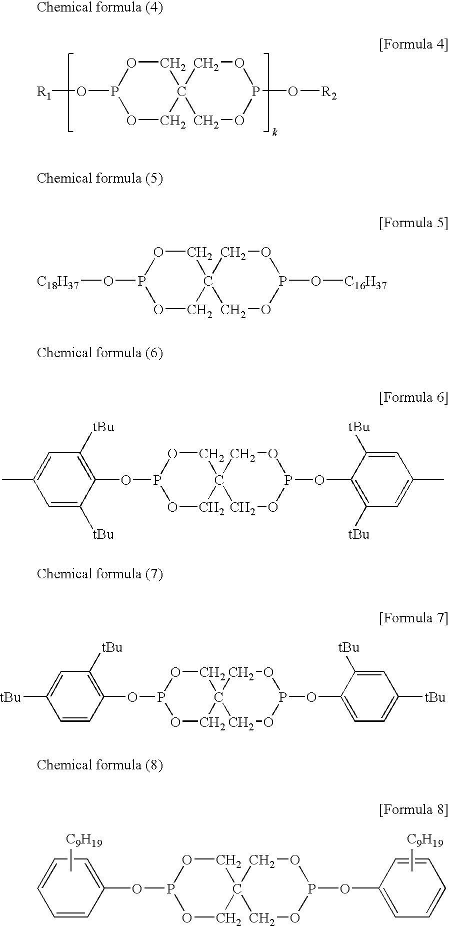

As a specific example of a phosphite based color inhibitor expressed by the following chemical formula (general formula) (9), the phosphite based color inhibitor expressed by the following chemical formulas (10) to (12) is preferable.

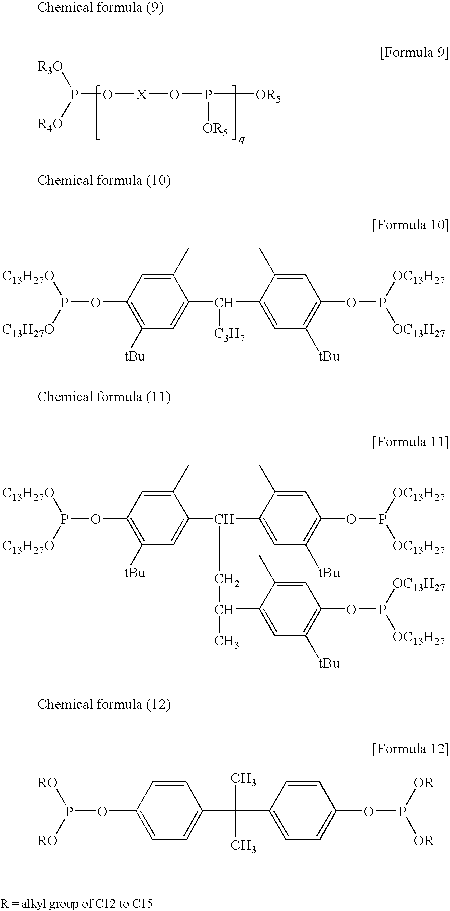

### (ii) Phosphorous Acid Ester Based Stabilizer

The phosphorous acid ester based stabilizer includes, for example, cyclic neopentane tetrailbis (octadecyl) phosphite, cyclic neopentane tetrailbis (2,4-di-t-buthylphenyl) phosphite, cyclic neopentane tetrailbis (2,6-di-t-butyl-4-methylphenyl) phosphite, 2,2-methylenebis(4,6-di-t-buthylphenyl) octyl phosphite, tris(2,4-di-t-buthylphenyl) phosphite, etc.

(iii) Other Stabilizers

Weak organic acids, thioether based compounds, epoxy compounds, and the like may be added as a stabilizer.

The weak organic acids have not less than 1 of pKa. The weak organic acids are not limited in particular unless the weak organic acids obstruct the action of the present invention and as long as they have color protection properties and properties to prevent deterioration of physical properties. For example, tartaric acid, citric acid, malic acid, fumaric acid, oxalic acid, succinic acid, maleic acid, etc. are included. These may be used alone, or not less than two kinds may be used together.

The thioether based compounds include dilauryl thiodipropionate, ditridecyl thiodipropionate, dimyristyl thiodipropionate, distearyl thiodipropionate, and palmityl stearyl thiodipropionate, for example. These may be used alone, or not less than two kinds may be used together.

The epoxy compounds include compounds derived from epichlorohydrin and bisphenol A, for example. Cyclic compounds, such as derivatives from epichlorohydrin and glycerol, vinylcyclohexene dioxide, and 3,4-epoxy-6-methylcyclohexylmethyl-3,4-epoxy-6-methylcyclohexane carboxylate, can also be used. Epoxidized soybean oil, epoxidized castor oil, and long chain-α-olefin oxides can be used. These may be used alone, or not less than two kinds may be used together.

### (3) Cellulose Acylate

### <<Cellulose Acylate Resin>>

### (Composition and a Degree of Substitution)

As for a cellulose acylate used in the present invention, a cellulose acylate that satisfies all requirements expressed by the following equations (1) to (3) is preferable.

2.0≦A+B≦3.0 equation (1)

0≦A≦2.0 equation (2)

1.0≦B≦2.9 equation (3)

(wherein in the above-mentioned equation (1) to equation (3), A designates the degree of substitution of an acetate group, and B designates a total of the degrees of substitution of a propionate group, a butyrate group, a pentanoly group, and a hexanoly group.)

### Preferably,

2.0≦A+B≦3.0 equation (4)

0≦A≦2.0 equation (5)

1.2≦B≦2.9 equation (6).

More preferably,

2.4≦A+B≦3.0 equation (7)

0.05≦A≦1.7 equation (8)

1.3≦B≦2.9 equation (9).

Still more preferably,

2.5≦A+B≦2.95 equation (10)

0.1≦A≦1.55 equation (11)

1.4≦B≦2.85 equation (12).

Thus, it is characteristic of the present invention to introduce a propionate group, a butyrate group, a pentanoly group, and a hexanoly group into cellulose to produce a cellulose acylate. The melting temperature can be reduced by setting the degree of substitution within such a range, thermal decomposition accompanied with melt film forming can be suppressed, and it is preferable. On the other hand, when the degree of substitution is out of this range, the melting temperature and a thermal decomposition temperature become closer to each other so that it is difficult to suppress thermal decomposition. Therefore, it is not preferable.

As for these cellulose acylates, only one kind may be used, or not less than two kinds may be mixed. A polymeric component other than the cellulose acylate may be properly mixed. Next, a method for producing a cellulose acylate used for the present invention will be described in detail. Raw material cotton for the cellulose acylate of the present invention and the synthesizing method therefor are described in detail also on pages 7 to 12 of Japan Institute of Invention and Innovation, (Kokai Giho Ko-Gi No. 2001-1745, published on Mar. 15, 2001 by the Japan Institution of Invention and Innovation).

### (Raw Material and Pretreatment)

As a cellulose raw material, hardwood pulp, softwood pulp, and a raw material derived from cotton linters are preferably used. Preferably, as the cellulose raw material, a cellulose raw material having high purity is used in which an α-cellulose content is not less than 92 mass % and not more than 99.9 mass %.

When the cellulose raw material has a shape of a film or a lump, preferably, the cellulose raw material is disintegrated in advance. Preferably, the cellulose is disintegrated until the cellulose becomes fluffy.

### (Activation)

Preferably, prior to acylation, treatment (activation) to contact the cellulose raw material with an activator is performed. A carboxylic acid or water can be used as the activator. However, the case where water is used preferably includes a step of adding an acid anhydride excessively after activation to dehydrate, a step of washing by a carboxylic acid in order to substitute water, a step of adjusting conditions of acylation, or the like, for example. The activator may be adjusted at any temperature and added. A method for adding the activator can be selected from methods such as spraying, dropping, immersion, and the like.

Carboxylic acids preferable as an activator are carboxylic acids having carbon atoms of not less than 2 and not more than 7 (for example, acetic acid, propionic acid, butyric acid, 2-methylpropionic acid, valeric acid, 3-methylbutyric acid, 2-methylbutyric acid, 2,2-dimethylpropanoic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexane carboxylic acid, benzoic acid, etc.); more preferably acetic acid, propionic acid, or butyric acid; and particularly preferably acetic acid.

In the time of activation, a catalyst for acylation such as sulfuric acid, etc. can be further added when necessary. However, addition of a strong acid as sulfuric acid may accelerate depolymerization. Accordingly, preferably, the amount of addition is approximately 0.1 mass % to 10 mass % to the cellulose at most. Additionally, not less than two kinds of the activators may be used together, or an acid anhydride derived from carboxylic acids having carbon atoms of not less than 2 carbon number and not more than 7 may be added.

Preferably, the amount of the addition of the activator is not less than 5 mass % to the cellulose, more preferably not less than 10 mass %, and particularly preferably not less than 30 mass %. When the amount of the activator is not less than the lower limit, it is preferable because defects such as reduction in a degree of activation of the cellulose are not produced. The amount of addition has no limitation in particular unless the upper limit of the amount of addition of the activator reduces productivity. However, preferably, the amount of addition is not more than 100 times in mass to the cellulose, more preferably not more than 20 times, and particularly preferably not more than 10 times. The activator may be very excessively added to the cellulose for activation, and subsequently, the amount of the activator may be reduced by filtration, drying by blowing the air, drying by heating, distilling off under reduced pressure, substitution of a solvent, etc.

A time of activation is preferably not less than 20 minutes. An upper limit in the time of activation has no limitation in particular when the upper limit is within a range such that productivity is not affected, and preferably not more than 72 hours, more preferably not more than 24 hours, and particularly preferably not more than 12 hours. Moreover, the temperature of activation is preferably not less than 0° C. and not more than 90° C., more preferably not less than 15° C. and not more than 80° C., and particularly preferably not less than 20° C. and not more than 60° C. The step of activation of the cellulose can also be performed under pressure or under reduced pressure conditions.

Moreover, electromagnetic waves such as microwave and infrared radiation, may be used as measure of heating.

### (Acylation)

In the method to manufacture the cellulose acylate in the present invention, preferably, a hydroxyl group of the cellulose is acylated by adding an acid anhydride derived from a carboxylic acid to the cellulose, and reacting the mixture with a Broensted acid or Lewis acid as a catalyst.

As a method for obtaining a cellulose mixed acylate, the following methods can be used: a method in which two kinds of carboxylic anhydrides are mixed or consecutively added as an acylating agent for reaction, a method in which a mixed acid anhydride of two kinds of carboxylic acids (for example, a mixed acid anhydride made of acetic acid and propionic acid) is used, a method in which acid anhydrides derived from a carboxylic acid and other carboxylic acid (for example, acetic acid and propionic anhydride) used as a raw material to synthesize a mixed acid anhydride (for example, a mixed acid anhydride of acetic acid and propionic acid) within a reaction system, and the mixed acid anhydride is reacted with the cellulose, a method in which cellulose acylate having the degree of substitution less than 3 is once synthesized, and remaining hydroxyl groups are further acylated using an acid anhydride or an acid halide, etc.

### (Acid Anhydride)

An acid anhydride derived from a carboxylic acid preferably has the carbon atoms of not less than 2 and not more than 7 as a carboxylic acid, and can include acetic anhydride, propionic anhydride, butyric acid anhydride, 2-methylpropionic acid anhydride, valeric acid anhydride, 3-methylbutyric acid anhydride, 2-methylbutyric acid anhydride, 2,2-dimethylpropanoic acid anhydride (pivalic acid anhydride), hexanoic acid anhydride, 2-methylvaleric acid anhydride, 3-methylvaleric acid anhydride, 4-methylvaleric acid anhydride, 2,2-dimethylbutyric acid anhydride, 2,3-dimethylbutyric acid anhydride, 3,3-dimethylbutyric acid anhydride, cyclopentane carboxylic acid anhydride, heptanoic acid anhydride, cyclohexane carboxylic acid anhydride, benzoic anhydride, etc., for example. More preferably, the acid anhydride derived from a carboxylic acid is anhydrides, such as acetic anhydride, propionic anhydride, butyric acid anhydride, valeric acid anhydride, hexanoic acid anhydride, and heptanoic acid anhydride, and particularly preferably acetic anhydride, propionic anhydride, and butyric acid anhydride.

Using these acid anhydrides together is preferable in order to prepare a mixed ester. Preferably, the mixing ratio of the acid anhydrides is determined according to a substitution ratio of the mixed ester to be prepared. An excessive equivalent of the acid anhydride is usually added to the cellulose. Namely, it is preferable that an equivalent of 1.2 to 50 is added to a hydroxyl group of the cellulose, more preferable that an equivalent of 1.5 to 30 is added, and particularly preferable that an equivalent of 2 to 10 is added.

### (Catalyst)

Preferably, a Broensted acid or a Lewis acid is used for a catalyst for acylation used to manufacture the cellulose acylate in the present invention. Definitions of the Broensted acid and the Lewis acid are described in the fifth edition (2000) of the “Rikagaku Jiten,” for example. Examples of preferable Broensted acids can include sulfuric acid, perchloric acid, phosphoric acid, methanesulfonic acid, benzenesulfonic acid, p-toluenesulfonic acid, etc. Examples of preferable Lewis acids can include zinc chloride, tin chloride, antimony chloride, magnesium chloride, etc.

As the catalyst, sulfuric acid or perchloric acid is more preferable, and sulfuric acid is particularly preferable. The preferable amount of addition of the catalyst is 0.1 to 30 mass % to the cellulose, more preferably 1 to 15 mass %, and particularly preferably 3 to 12 mass %.

### (Solvent)

When acylating, a solvent may be added in order to adjust a viscosity, a reaction rate, a stirring property, an acyl substitution ratio, etc. As such a solvent, dichloromethane, chloroform, carboxylic acids, acetone, ethyl methyl ketone, toluene, dimethyl sulfoxide, sulfolane, etc. can be used. However, carboxylic acids are preferable, and can include carboxylic acids having carbon atoms of not less than 2 and not more than 7 {for example, acetic acid, propionic acid, butyric acid, 2-methylpropionic acid, valeric acid, 3-methylbutyric acid, 2-methylbutyric acid, 2,2-dimethylpropanoic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid}, etc., for example. More preferably, acetic acid, propionic acid, butyric acid, etc. can be included. These solvents may be mixed and used.

### (Conditions of Acylation)

When acylating, the catalyst may be mixed with the acid anhydride and further with a solvent when necessary, and subsequently may be mixed with the cellulose; or these may be separately mixed with the cellulose consecutively. However, usually, it is preferable that a mixture of the acid anhydride and the catalyst or a mixture of the acid anhydride, the catalyst, and the solvent is adjusted as an acylating agent, and subsequently reacted with the cellulose. In order to suppress increase in a temperature within a reaction chamber caused by reaction heat in the time of acylation, preferably, the acylating agent is cooled in advance. As a cooling temperature, −50° C. to 20° C. are preferable, −35° C. to 10° C. are more preferable, and −25° C. to 5° C. are particularly preferable. The acylating agent may be liquefied and added, or may be frozen into a crystal, a flake, or a solid of a block-like shape and added.

Further, the acylating agent may be added at one time to the cellulose, or may be added several times. Moreover, the cellulose may be added at one time to the acylating agent, or may be added several times. When the acylating agent is added several times, an acylating agent having the same composition may be used, or a plurality of acylating agents each having a different composition may be used. Preferable examples can include: 1) first, add the mixture of the acid anhydride and the solvent, and then, add the catalyst; 2) first, add a mixture made of the acid anhydride, the solvent, and a part of the catalyst, and then, add a mixture of the remaining catalyst and the solvent; 3) first, add a mixture of the acid anhydride and the solvent, and then, add a mixture of the catalyst and the solvent; 4) first, add the solvent, and add a mixture of the acid anhydride and the catalyst or a mixture of the acid anhydride, the catalyst, and the solvent, etc.

Acylation of the cellulose is an exothermic reaction. In the method for producing the cellulose acylate according to the present invention, the highest arrival temperature in the time of acylation is preferably not more than 50° C. When the reaction temperature is not more than this temperature, no inconvenience occurs such that progress of depolymerization makes it difficult to obtain the cellulose acylate having a polymerization degree suitable for applications of the present invention, and therefore it is preferable. The highest arrival temperature in the time of acylation is preferably not more than 45° C., more preferably not more than 40° C., and particularly preferably not more than 35° C. The reaction temperature may be controlled using a thermostat, or may be controlled based on an initial temperature of the acylating agent. Moreover, pressure of the reaction chamber can be reduced, and the reaction temperature can be controlled by heat of vaporization of a liquid component in the reaction system. Because generation of heat in the time of acylation is larger at an early stage of the reaction, control can be performed by cooling at the early stage of the reaction and subsequently heating, or the like. An end point of acylation can be determined by measures such as light transmittance, viscosity of the solution, temperature change of the reaction system, and solubility of a reactant to an organic solvent, observation by a polarizing microscope, and the like.

The lowest temperature of the reaction of not less than −50° C. is preferable, that of not less than −30° C. is more preferable, and that of not less than −20° C. are particularly preferable. Preferable acylation time is not less than 0.5 hours and not more than 24 hours, more preferably not less than 1 hour and not more than 12 hours, and particularly preferably not less than 1.5 hours and not more than 6 hours. When the acylation time is not more than 0.5 hours, the reaction does not sufficiently progress under normal reaction conditions. When the acylation time exceeds 24 hours, it is not preferable from a viewpoint of industrial production.

### (Reaction Terminator)

In the method for producing the cellulose acylate used for the present invention, preferably, a reaction terminator is added after the acylation reaction.

The reaction terminator may be any reaction terminator that decomposes acid anhydrides. Preferable examples can include water, alcohols (for example, ethanol, methanol, propanol, isopropyl alcohol, etc.), or a composition containing these. The reaction terminator may also include a neutralizer mentioned later. Upon addition of the reaction terminator, in order to avoid inconvenience such that large generation of heat exceeding a cooling capacity of the reactor occurs to cause reduction in the polymerization degree of the cellulose acylate, or the cellulose acylate may precipitate in an undesired form, it is preferable that a mixture of the carboxylic acid such as acetic acid, propionic acid, and butyric acid and water is added, rather than adding water and alcohol directly. As the carboxylic acid, acetic acid is particularly preferable. A composition ratio of the carboxylic acid and water can be used in an arbitrary proportion.

However, a content of water is within the range of 5 mass % to 80 mass %, more preferably 10 mass % to 60 mass %, and particularly preferably 15 mass % to 50 mass %.

The reaction terminator may be added to the reaction chamber for acylation, or the reactant may be added into a container of the reaction terminator. Preferably, the reaction terminator is added over 3 minutes to 3 hours. When the time to add the reaction terminator is not less than 3 minutes, it is preferable because inconvenience does not occur such that excessive generation of heat causes reduction in the polymerization degree, insufficient hydrolysis of the acid anhydride, or reduction in stability of the cellulose acylate. Moreover, when the time to add the reaction terminator is not more than 3 hours, it is preferable because no problem of reduction in industrial productivity occurs, either. The time to add the reaction terminator is preferably not less than 4 minutes and not more than 2 hours, more preferably not less than 5 minutes and not more than 1 hour, and particularly preferably not less than 10 minutes and not more than 45 minutes. The reaction chamber may be cooled or may not be cooled at the time of adding the reaction terminator. However, preferably, the reaction chamber is cooled to suppress increase in the temperature in order to suppress depolymerization. Cooling of the reaction terminator is also preferable.

### (Neutralizer)

In the acylation reaction terminating step or after the acylation reaction terminating step, a neutralizer (for example, carbonates, acetates, hydroxides, or oxides of calcium, magnesium, iron, aluminum, or zinc) or a solution thereof may be added for hydrolysis of excessive anhydrous carboxylic acids that remain within the system and neutralization of a part or all of the carboxylic acid and esterification catalyst. As a preferable example, a solvent for the neutralizer can include water, alcohols (for example, ethanol, methanol, propanol, isopropyl alcohol, etc.) carboxylic acids (for example, acetic acid, propionic acid, butyric acid, etc.), ketones (for example, acetone, ethyl methyl ketone, etc.), polar solvents such as dimethyl sulfoxide, etc., and mixed solvents of these.

### (Partial Hydrolysis)

The thus-obtained cellulose acylate has a total degree of substitution close to approximately 3. However, in order to obtain a cellulose acylate having a desired degree of substitution, reduction of the degree of acyl substitution of the cellulose acylate to the desired degree (the so-called ripening) is generally performed by maintaining the cellulose acylate at 20 to 90° C. for several minutes to several days under presence of a small amount of a catalyst (usually, the remaining acylation catalyst such as sulfuric acid) and water to partially hydrolyze an ester bond. Sulfuric ester of the cellulose is also hydrolyzed in the process of partial hydrolysis. Accordingly, an amount of sulfuric ester bonded to the cellulose can be reduced by adjusting conditions of hydrolysis.

At a point of time when the desired cellulose acylate is obtained, preferably, the catalyst that remains within the system is neutralized completely by using the above-mentioned neutralizer or the solution thereof to stop partial hydrolysis. It is also preferable that the catalyst (for example, sulfuric ester) in the solution or the catalyst bonded to the cellulose is removed effectively by adding a neutralizer that produces a salt having lower solubility to the reaction solution (for example, magnesium carbonate, magnesium acetate, etc.).

### (Filtration)

Preferably, in order to remove or reduce unreacted materials, sparingly soluble salts, and other foreign substances, and the like in the cellulose acylate, a reaction mixture (dope) is filtered. Filtration may be performed in any step from completion of acylation to reprecipitation. In order to control filtration pressure and handling properties, dilution by an appropriate solvent prior to filtration is also preferable.

### (Reprecipitation)

By mixing the thus-obtained cellulose acylate solution into water or a poor solvent such as an aqueous solution of a carboxylic acid (for example, acetic acid, propionic acid, etc.) or mixing the poor solvent into the cellulose acylate solution, the cellulose acylate can be reprecipitated, and a target cellulose acylate can be obtained by washing and stabilizing treatment. Reprecipitation may be performed continuously, or may be performed in batches of a fixed amount. It is also preferable that a form and molecular weight distribution of the reprecipitated cellulose acylate are controlled by adjusting a concentration of the cellulose acylate solution and a composition of the poor solvent in accordance with a substitution form or polymerization degree of the cellulose acylate.

### (Washing)

Preferably, the produced cellulose acylate is subjected to washing treatment. Any washing solvent may be used as long as solubility of the cellulose acylate is low to the washing solvent and the washing solvent can remove impurities. Generally, water or warm water is used. A temperature of the washing water is preferably 25° C. through 100° C., more preferably 30° C. through 90° C., and particularly preferably 40° C. through 80°. The washing treatment may be performed by the so-called batch process in which filtration and replacement of the washing liquid are repeated, or may be performed using a continuous washing apparatus. It is also preferable that a waste liquid produced during the steps of reprecipitation and washing is reused as the poor solvent in the reprecipitation step, or that the solvent such as carboxylic acids is recovered by distillation or other measures to be reused.

Although progress of washing may be tracked by any measure, as a preferable example, methods using hydrogen ion concentration, ion chromatography, electric conductivity, ICP, elemental analysis, and atomic absorption spectrum, and the like can be included.

By such treatment, the catalyst (sulfuric acid, perchloric acid, trifluoroacetic acid, p-toluenesulfonic acid, methanesulfonic acid, zinc chloride, etc.) in the cellulose acylate, the neutralizer (for example, carbonates, acetates, hydroxides, or oxides of calcium, magnesium, iron, aluminum, or zinc, etc.), the reactant with the neutralizer and the catalyst, the carboxylic acid (acetic acid, propionic acid, butyric acid, etc.), the reactant with the neutralizer and the carboxylic acid, etc. can be removed. This is effective in order to increase stability of the cellulose acylate.

### (Stabilization)

Preferably, in order to further improve stability or to reduce carboxylic acid smell, the cellulose acylate after washing by warm water treatment is also processed in an aqueous solution of weak alkali (for example, carbonates, hydrogencarbonates, hydroxides, oxides of sodium, potassium, calcium, magnesium, and aluminum, etc.) and the like.

An amount of residual impurities can be controlled by an amount of the washing liquid, a temperature of washing, time, a stirring method, a form of a washing container, and a composition and concentration of a stabilizing agent. In the present invention, conditions of acylation, partial hydrolysis, and washing are set so that an amount of residual sulfate radicals (as a content of sulfur atoms) may be 0 to 500 ppm.

### (Drying)

In the present invention, in order to adjust a moisture content of the cellulose acylate to a preferable amount, preferably, the cellulose acylate is dried. A method for drying is not limited in particular as long as a target moisture content is obtained. However, preferably, drying is efficiently performed by using measures such as heating, air blowing, reduced pressure, stirring alone or in combination. A drying temperature is preferably 0 to 200° C., more preferably 40 to 180° C., and particularly preferably 50 to 160° C. The moisture content of the cellulose acylate according to the present invention is preferably not more than 2 mass %, more preferably not more than 1 mass %, and particularly preferably not more than 0.7 mass %.

### (Form)

The cellulose acylate according to the present invention can have various forms such as forms of particles, powders, fibers, and lumps. However, as a raw material for film production, a particle form or a powder form is preferable. Accordingly, the cellulose acylate after drying may be crushed or sifted through a sieve for uniformity of a particle size and improvement in handling properties. When the cellulose acylate has a particle form, preferably, not less than 90 mass % of the particles to be used has a particle size of 0.5 to 5 mm. Moreover, preferably, not less than 50 mass % of the particles to be used has a particle size of 1 to 4 mm. Preferably, the cellulose acylate particles have a form as closer to a globular form as possible. Moreover, an apparent density of the cellulose acylate particles according to the present invention is preferably 0.5 through 1.3, more preferably 0.7 through 1.2, and particularly preferably 0.8 through 1.15. Measurement of the apparent density is specified in JIS K-7365.

An angle of repose of the cellulose acylate particles according to the present invention is preferably 10 through 70°, more preferably 15 through 60°, and particularly preferably 20 through 50°.

### (Polymerization Degree)

The polymerization degree of cellulose acylate preferably used in the present invention is an average degree of polymerization 100 to 300, preferably 120 to 250, and more preferably 130 to 200. The average degree of polymerization can be measured by methods such as a limiting viscosity method by Uda et al. (Kazuo Uda, Hideo Saito; the Journal of the Society of Fiber Science and Technology of Japan, Vol. 18, No. 1, pp. 105-120, 1962), measurement of molecular weight distribution by gel permeation chromatography (GPC), etc. It is described in detail in Japanese Patent Application Laid-Open No. 09-95538.

In the present invention, a weight average degree of polymerization /a number average degree of polymerization of the cellulose acylate by GPC is preferably 1.6 through 3.6, more preferably 1.7 through 3.3, and particularly preferably 1.8 through 3.2.

As for these cellulose acylates, only one kind may be used, or not less than two kinds may be mixed. A polymeric component other than the cellulose acylates may be properly mixed. Preferably, the polymeric component to be mixed has excellent compatibility with cellulose esters. Transmittance when the film is formed is not less than 80%, more preferably not less than 90%, and still more preferably not less than 92%.

### Examples of Synthesis of Cellulose Acylate

Hereinafter, further detailed description will be given of Examples of synthesis of the cellulose acylate used for the present invention. However, the present invention will not be limited to these.

### Synthesis Example 1

### Synthesis of Cellulose Acetate Propionate

Cellulose (hardwood pulp) of 150 g and acetic acid of 75 g were placed into a 5-L separable flask as a reaction container to which a reflux apparatus was attached. The mixture was stirred intensely for 2 hours while being heated in an oil bath whose temperature was adjusted at 60° C. The cellulose subjected to such a pretreatment was swelled and disintegrated to become fluffy. The reaction container was placed in a 2° C. ice water bath for 30 minutes, and cooled.

Separately, a mixture of 1545 g of propionic anhydride and 10.5 g of sulfuric acid were produced as an acylating agent. The mixture was cooled to −30° C., and subsequently added to the reaction container that accommodates the cellulose subjected to the above-mentioned pretreatment at one time. After 30 minutes passed, an external temperature was gradually increased, and adjusted so that an internal temperature might reach to 25° C. after 2 hours passed from the time of adding the acylating agent. The reaction container was cooled in a 5° C. ice water bath, and adjusted so that the internal temperature might reach to 10° C. after 0.5 hours from addition of the acylating agent and the internal temperature might reach to 23° C. after 2 hours. The internal temperature was maintained at 23° C., and stirring was further performed for 3 hours. The reaction container was cooled in a 5° C. ice water bath, and 25 mass % hydrous acetic acid of 120 g cooled to 5° C. was added over 1 hour. The internal temperature was increased to 40° C., and stirring for 1.5 hours was performed. Next, a solution obtained by dissolving magnesium acetate 4-hydrate of a mol twice the amount of sulfuric acid in 50 mass hydrous acetic acid was added into the reaction container, and stirred for 30 minutes. Then, 25 mass % hydrous acetic acid of 1 L, 33 mass % hydrous acetic acid of 500 mL, 50 mass % hydrous acetic acid of 1 L, and water 1 L were added in this order to precipitate cellulose acetate propionate. The obtained precipitate of cellulose acetate propionate was washed by warm water. By changing washing conditions at this time as shown in Table 1, each cellulose acetate propionate having a different amount of residual sulfuric acid radicals was obtained. After washing, the precipitate was stirred for 0.5 hours in a 20° C. 0.005 mass % hydroxide calcium aqueous solution. The precipitate was further washed by water until a pH of the washing liquid becomes 7, and subsequently dried in vacuum at 70° C.

According to 1H-NMR and GPC measurement, the obtained cellulose acetate propionate had a degree of acetylation of 0.30, a degree of propionylation of 2.63, and a polymerization degree of 320. A content of sulfuric acid radicals was measured by ASTMD-817-96.

### Synthesis Example 2

### Synthesis of Cellulose Acetate Butylate

Cellulose (hardwood pulp) of 100 g and acetic acid of 135 g were placed into a 5-L separable flask as a reaction container to which a reflux apparatus was attached. The mixture was left for 1 hour while being heated in an oil bath adjusted at 60° C. Subsequently, the mixture was stirred intensely for 1 hour while being heated in the oil bath adjusted at 60° C. The cellulose subjected to such a pretreatment was swelled and disintegrated to become fluffy. The reaction container was placed into a 5° C. ice water bath for 1 hour, and the cellulose was sufficiently cooled.

Separately, a mixture of 1080 g of butyric acid anhydride and 10.0 g of sulfuric acid were produced as the acylating agent. The mixture was cooled to −20° C., and subsequently added into the reaction container that accommodates the cellulose subjected to pretreatment at one time. After 30 minutes passed, the external temperature was increased to 20° C., and a reaction was performed for 5 hours. The reaction container was cooled in a 5° C. ice water bath, and 2400 g of 12.5 mass % hydrous acetic acid cooled to approximately 5° C. was added over 1 hour. The internal temperature was increased to 30° C., and stirring was performed for 1 hour. Next, 100 g of a 50 mass aqueous solution of magnesium acetate 4-hydrate was added into the reaction container, and stirring was performed for 30 minutes. Then, 1000 g of acetic acid and 2500 g of 50 mass % hydrous acetic acid were added gradually to precipitate cellulose acetate butylate. The obtained precipitate of cellulose acetate butylate was washed by warm water. By changing the washing conditions at this time as shown in Table 1, each cellulose acetate butylate having a different amount of residual sulfuric acid radicals was obtained. After washing, the precipitate was stirred in a 0.005 mass % hydroxide calcium aqueous solution for 0.5 hours. The precipitate was further washed by water until a pH of the washing liquid becomes 7, and subsequently dried at 70° C. The obtained cellulose acetate butylate had a degree of acetylation of 0.84, a degree of butyrylation of 2.12, and a polymerization degree of 268.

### (4) Other Additives

### (i) Matting Agent

Preferably, particulates are added as a matting agent. The particulates used for the present invention can include silicon dioxide, titanium dioxide, aluminum oxide, zirconium oxide, calcium carbonate, calcium carbonate, talc, clay, calcined kaolin, calcined calcium silicate, calcium silicate hydrate, aluminum silicate, magnesium silicate, and calcium phosphate. Particulates including silicon can reduce turbidity, and therefore are preferable. Silicon dioxide is particularly preferable. Preferably, the particulates of silicon dioxide have a primary mean particle diameter of not more than 20 nm, and have an apparent specific gravity of not less than 70 g/lit. Particulates having a small mean diameter of primary particles such as 5 to 16 nm can reduce a haze of a film, and are more preferable. The apparent specific gravity is preferably not less than 90 to 200 g/lit., and more preferably not less than 100 to 200 g/lit. As the apparent specific gravity is larger, a dispersion liquid can be prepared in a higher concentration. This improves the haze and aggregates, and it is preferable.

These particulates usually form a secondary particle having a mean particle diameter of 0.1 to 3.0 μm. These second particles exist as an aggregate of the primary particles in the film, and form projections and depressions of 0.1 to 3.0 μm on a film surface. The secondary mean particle diameter of not less than 0.2 μm and not more than 1.5 μm is preferable, that of not less than 0.4 μm and not more than 1.2 μm is more preferable, and that of not less than 0.6 μm and not more than 1.1 μm is most preferable. The primary particle size and secondary particle size were determined by observing the particles in the film by a scanning electron microscope, and defining a diameter of a circle circumscribed on the particle as a particle size. Moreover, 200 particles were observed at different places, and the average value thereof was defined as the mean particle diameter.

As the particulates of silicon dioxide, marketed commodity such as Aerosil R972, R972V, R974, R812, 200, 200V, 300, R202, OX50, and TT600 (all made by Nippon Aerosil Co., Ltd.) can be used, for example. The particulates of zirconium oxide are commercially available under a trade name of Aerosil R976 and R811 (all made by Nippon Aerosil Co., Ltd.), for example, and can be used.

Among these, Aerosil 200V and Aerosil R972V are particulates of silicon dioxide having a primary mean particle diameter of not more than 20 nm, and having an apparent specific gravity of not less than 70 g/lit. These two products are particularly preferable because they have a large effect of reducing a coefficient of friction while keeping turbidity of an optical film low.

### (ii) Other Additives

Other than the above-mentioned additives, various additives, for example, a UV protective agent (for example, hydroxy benzophenone based compounds, benzotriazol based compounds, salicylate ester based compounds, cyanoacrylate based compounds, etc.), an infrared absorbent an optical regulator, a surfactant, an odor trapping agent (amine and the like), etc. can be added. Details of them are described on pages 17 to 22 of Japan Institute of Invention and Innovation, Kokai Giho Ko-Gi No. 2001-1745 (published on Mar. 15, 2001 by the Japan Institution of Invention and Innovation), and materials described in this report may be preferably used.

An infrared absorbing dye described in Japanese Patent Application Laid-Open No. 2001-194522 can be used as an infrared absorbing dye. An UV absorbent described in Japanese Patent Application Laid-Open No. 2001-151901 can be used as a UV absorbent. Preferably, the infrared absorbing dye and the UV absorbent are respectively contained in a range of 0.001 to 5 mass % to the cellulose acylate.

The optical regulator can include a retardation regulator, and can use retardation regulators described, for example, in Japanese Patent Application Laid-Open Nos. 2001-166144, 2003-344655, 2003-248117, and 2003-66230. Thereby, the in-plane retardation (Re) and the thickness-direction retardation (Rth) can be controlled. A preferable amount of addition is 0 to 10 wt %, more preferably 0 to 8 wt %, and still more preferably 0 to 6 wt %.

### (5) Physical Properties of the Cellulose Acylate Mixture

Preferably, the above-mentioned cellulose acylate mixture (the mixture of the cellulose acylate, the plasticizer, the stabilizer, and other additives) satisfies the following physical properties.

### (i) Weight Loss

In the thermoplastic cellulose acetate propionate composition of the present invention, a ratio of heating loss at 220° C. is not more than 5 weight %. Here, the ratio of heating loss means a ratio of weight loss at 220° C. when a temperature of a sample is raised from room temperature at a temperature raising velocity of 10° C./min. under a nitrogen gas atmosphere. By using the above-mentioned cellulose acylate mixture, the ratio of heating loss can be controlled so as to be not more than 5 weight %. The ratio of heating loss is more preferably not more than 3 weight %, and still more preferably not more than 1 weight %. Thereby, failures (production of bubbles) produced during film forming can be suppressed.

### (ii) Melt Viscosity

In the thermoplastic cellulose acetate propionate composition of the present invention, a melt viscosity per 1 sec⁻¹ at 220° C. is preferably 100 to 1000 Pa·sec, more preferably 200 to 800 Pa·sec, and still more preferably 300 to 700 Pa·sec. When the higher melt viscosity is set as mentioned above, extension (drawing) by a tension force at the die outlet does not occur, and increase in optical anisotropy (retardation) attributed to drawing orientation can be prevented.

Such a viscosity may be adjusted by any method, and can be adjusted by the polymerization degree of the cellulose acylate and the amount of the additives such as the plasticizer, for example.

### (6) Pelletizing

Preferably, the above-mentioned cellulose acylate and additives are mixed to be pelletized prior to melting film forming.

Preferably, in pelletizing, the cellulose acylate and additives are dried in advance. However, a vent type extruder can be used instead of drying in advance. When drying, a method for heating at 90° C. within a heating furnace for not less than 8 hours, etc. can be used as a drying method, but the drying method is not limited to this. Pelletizing can be performed as follows. The above-mentioned cellulose acylate and additives are molten at a temperature of not less than 150° C. and not more than 250° C. using a twin screw kneading extruder. Subsequently, the mixture extruded into a noodle shape is solidified in water and cut. Alternatively, pelletizing may be performed by an underwater cut method in which after melting by the extruder, the mixture is cut while being directly extruded from a nozzle into water.

Any known single screw extruders, non-intermeshing counter-rotating twin screw extruders, intermeshing counter-rotating twin screw extruders, intermeshing co-rotating twin screw extruders, etc. can be used for the extruder as long as sufficient melt and kneading are obtained.

As a size of the pellet, preferably, an cross-section area is not less than 1 mm² and not more than 300 mm² and a length is not less than 1 mm and not more than 30 mm, and more preferably, a cross-section area is not less than 2 mm² and not more than 100 mm² and a length is not less than 1.5 mm and not more than 10 mm.

When pelletizing, the above-mentioned additives can also be fed from a material supplying inlet or a vent opening that exists in the course of the extruder.

The extruder preferably has the number of rotation of not less than 10 rpm and not more than 1000 rpm, more preferably that of not less than 20 rpm and not more than 700 rpm, and still more preferably that of not less than 30 rpm and not more than 500 rpm. When the rotational speed becomes slower than this range, the residence time becomes longer. Accordingly, it is not preferable because the molecular weight is reduced by thermal deterioration, or yellowness is likely to deteriorate. Moreover, when the rotational speed is too fast, the molecules are more likely to be cut by shearing, therefore to cause problems of reduction in the molecular weight or increase in a crosslinked gel.

The extrusion residence time in pelletizing is not less than 10 seconds and not more than 30 minutes, more preferably not less than 15 seconds and not more than 10 minutes, and still more preferably not less than 30 seconds and not more than 3 minutes. When sufficient melting is possible, a shorter residence time is preferable because it is possible to suppress deterioration of the resin and occurrence of yellowness.

### (7) Melt FILM FORMING

### (i) Drying

The pellet produced by the above-mentioned method is preferably used, and moisture in the pellet is preferably reduced prior to melt film forming.

In order to adjust a moisture content of the cellulose acylate to a preferable amount in the present invention, the cellulose acylate is preferably dried. As a method of drying, drying by using a dehumidification air dryer is often performed, but will not be limited in particular as long as a target moisture content is obtained (Preferably, measures such as heating, air blowing, reduced pressure, and stirring are used alone or in combination for efficient drying, and more preferably, a drying hopper has a heat insulated structure.). A drying temperature is preferably 0 to 200° C., more preferably 40 to 180° C., and particularly preferably 60 to 150° C. When the drying temperature is too low, it is not preferable because drying needs longer time. In addition to this, the moisture content cannot be controlled so as to be not more than the target value. On the other hand, when the drying temperature is too high, it is not preferable because the resin sticks and blocks. The amount of drying air is preferably 20 to 400 m³/hour, more preferably 50 to 300 m³/hour, and particularly preferably 100 to 250 m³/hour. When the amount of drying air is small, it is not preferable because drying efficiency is poor. On the other hand, even if the amount of air is increased beyond a fixed amount, further improvement in the drying effect is hardly expected, and it is not economical. The dew point of air is preferably 0 to −60° C., more preferably −10 to −50° C., and particularly preferably −20 to −40° C. The drying time needed is at least not less than 15 minutes, more preferably not less than 1 hour, and particularly preferably not less than 2 hours. On the other hand, an effect of further reducing the moisture content is hardly obtained even by drying the pellet over 50 hours. Accordingly, such an unnecessarily long drying time is not preferable because thermal deterioration of the resin may be produced. The cellulose acylate according to the present invention preferably has a moisture content of not more than 1.0 mass %, more preferably that of not more than 0.1 mass %, and particularly preferably that of not more than 0.01 mass %.

### (ii) Melt Extruding

The cellulose acylate resin mentioned above is fed into a cylinder through a feed opening of an extruder (different from the extruder for the above-mentioned pelletizing). Sequentially from the feed opening side, an inside of the cylinder includes a feed section (region A) for conveying a fixed amount of the cellulose acylate resin fed from the feed opening, a compression section (region B) for melting, kneading, and compressing the cellulose acylate resin, and a measuring section (region C) for measuring the molten, kneaded, and compressed cellulose acylate resin. The resin is preferably dried by the above-mentioned method in order to reduce the moisture content. However, in order to prevent oxidization of the molten resin caused by remaining oxygen, more preferably, drying is performed while the inside of the extruder is evacuated in an inert gas (nitrogen, etc.) or using an extruder with a vent opening. A screw compression ratio of the extruder is set at 2.5 to 4.5, and an L/D is set at 20 to 70. Here, the screw compression ratio is a volume ratio of the feed section A and the measuring section C, and in other words, is expressed by a volume per unit length of the feed section A/a volume per unit length of the measuring section C. The screw compression ratio is calculated by using an outer diameter dl of the screw shaft in the feed section A, an outer diameter d2 of the screw shaft in the measuring section C, a diameter a1 of a slot in the feed section A, and a diameter a2 of a slot in the measuring section C. Moreover, the L/D is a ratio of a cylinder length to a cylinder inner diameter. An extrusion temperature is set at 190 to 240° C. When the temperature within the extruder exceeds 240° C., a cooler may be provided between the extruder and the die.

When the screw compression ratio is less than 2.5 and too small, melting and kneading is insufficient so that an undissolved portion is produced, and small shear heating makes dissolution of a crystal insufficient. Fine crystals are likely to remain in the cellulose acylate film after production, and further bubbles are likely to be mixed. Thereby, when the strength of the cellulose acylate film decreases or the film is stretched, the remaining crystals obstruct stretchability and make it impossible to sufficiently increase orientation. On the other hand, when the screw compression ratio exceeds 4.5 and is too large, an excessive shear stress is applied so that the resin easily deteriorates by generation of heat. For that reason, yellowness is likely to be caused in the cellulose acylate film after production. Moreover, when an excessive shear stress is applied, a molecule is cut so that a molecular weight is reduced. Thereby, mechanical strength of the film is reduced. Accordingly, in order to make it unlikely to cause yellowness in the cellulose acylate film after production and extension breakage, the screw compression ratio is preferably within the range of not less than 2.5 and not more than 4.5, more preferably within the range of not less than 2.8 and not more than 4.2, and particularly preferably within the range of not less than 3.0 and not more than 4.0.

Moreover, when the L/D is less than 20 and too small, insufficient molten and insufficient kneading occur. Fine crystals are likely to remain in the cellulose acylate film after production similarly to the case where the compression ratio is small. On the other hand, when the L/D exceeds 70 and is too large, residence time of the cellulose acylate resin within the extruder becomes too long, and the resin easily deteriorates. Moreover, when the residence time becomes longer, a molecule is cut so that a molecular weight is reduced. Thereby, mechanical strength of the cellulose acylate film is reduced. Accordingly, in order to make it unlikely to cause yellowness in the cellulose acylate film after production and extension breakage, the L/D is preferably within the range of not less than 20 and not more than 70, more preferably within the range of not less than 22 and not more than 65, and particularly preferably within the range of not less than 24 and not more than 50.

Moreover, preferably, the extrusion temperature is within the above-mentioned range of temperature. The thus-obtained cellulose acylate film has property values of a yellow index (YI value) of not more than 2.0% of a haze and not more than 10.

Here, the haze is an index showing whether the extrusion temperature is too low or not. In other words, the haze is an index showing an amount of crystals that remain in the cellulose acylate film after production. The haze exceeding 2.0% is likely to cause reduction in strength of the cellulose acylate film after production and breakage at the time of extension. Moreover, the yellow index (YI value) is an index showing whether the extrusion temperature is too high or not. When the yellow index (YI value) is not more than 10, there is no problem in the yellowness.

Generally, as a kind of the extruder, single screw extruders having a comparatively inexpensive equipment cost are often used. The screw type includes Full flight, Madoc, Dulmage, and the like, and the Full flight type is preferable for the cellulose acylate resin whose thermal stability is relatively poorer. Moreover, although the equipment cost is expensive, it is possible to use twin screw extruders that can extrude while devolatilizing unnecessary volatile components through a vent opening provided halfway by changing a screw segment. The twin screw extruders are largely classified into a co-rotating type and a counter-rotating type. Although both of the types can be used, the co-rotating type is preferable because the co-rotating type has high self-cleaning performance and hardly produces a stagnation portion. In spite of the expensive cost, the twin screw extruders have high kneading properties and high resin feed performance, allowing extrusion at a lower temperature. For that reason, the twin screw extruder is suitable for producing the film made of the cellulose acetate resin. By disposing the vent opening properly, undried cellulose acylate pellets and powders can also be used as it is. Pieces or the like of the film formed in the course of film forming can also be reused as it is without being dried.

A preferable diameter of the screw varies depending on a target amount of extrusion per unit time, and is not less than 10 mm and not more than 300 mm, more preferably not less than 20 mm and not more than 250 mm, and still more preferably not less than 30 mm and not more than 150 mm.

(iii) Filtration

Filtration of the so-called breaker plate type is preferable, in which a filter medium is provided in the extruder outlet in order to avoid damages in a gear pump caused by filtration of foreign substances in the resin or by foreign substances. Moreover, in order to filter foreign substances with higher accuracy, a filtration apparatus into which the so-called leaf type disc filter is incorporated is preferably provided at a rear stage of the gear pump. Filtration can be performed by providing one filtration section, or multi stage filtration by providing the filtration section at several places may be performed. Higher filtering accuracy of the filter medium is preferable. However, the filtering accuracy is preferably 15 μm to 3 μm in consideration of withstanding pressure of the filter medium and increase in filtering pressure due to clogging of the filter medium, and more preferably 10 μm to 3 p.m. Particularly when the leaf type disc filter apparatus for final filtration of foreign substances is used, the filter medium having high filtering accuracy from a viewpoint of quality is preferably used. In order to ensure an appropriate withstanding pressure and filter life, the filtering accuracy can be adjusted by the number of filters to be mounted. A kind of the filter medium to be used is preferably iron steel materials from a viewpoint of use under high temperature and high pressure. Stainless steel, steel, and the like are particularly preferably used among the iron steel materials. It is particularly desirable to use stainless steel from a viewpoint of corrosion. The filtering medium can be formed by knitting a wire rod material. Besides this, a sintered filtering medium formed by sintering metal long fibers or metal powders, for example, can be used. From a viewpoint of filtering accuracy and filter life, the sintered filtering medium is preferable.

### (iv) Gear Pump

In order to improve thickness accuracy, it is important to reduce fluctuation of an amount of discharge. It is effective to provide a gear pump between the extruder and the die to feed a fixed amount of the cellulose acylate resin from the gear pump. The gear pump accommodates a pair of gears of a drive gear and a driven gear meshing with each other. By driving the drive gear and meshing both of the gears with each other to rotate, the gear pump sucks the molten resin into a cavity from a suction opening formed in a housing. The gear pump also discharges a fixed amount of the resin from a discharge opening formed in the housing. Even if resin pressure slightly fluctuates in an end portion of the extruder, the fluctuation is absorbed by the gear pump in use. As a result, the fluctuation of the resin pressure downstream of the film forming apparatus becomes very small so that fluctuation of the thickness is improved. Use of the gear pump allows a fluctuation range of the resin pressure in the die part to be within ±1% (inclusive).

In order to improve performance of feeding a fixed amount by the gear pump, a method of controlling pressure upstream of the gear pump so as to be constant by changing of the number of rotation of the screw can also be used. A high precision gear pump in which not less than 3 gears are used to eliminate fluctuation of the gear in the gear pump is also effective.

There are other merits of using the gear pump. The film can be formed at a reduced pressure of the end portion of the screw. Thereby, reduction in energy consumption, prevention of increase in the resin temperature, improvement in transport efficiency, shortening of the residence time within the extruder, and reduction in the L/D of the extruder can be expected. Moreover, when the filter is used to remove foreign substances, without a gear pump, an amount of the resin fed from the screw may be fluctuated together with increase in the filtering pressure. However, this fluctuation can be eliminated by using the gear pump in combination. On the other hand, there are demerits of the gear pump. Depending on a method to select the equipment, the length of the equipment becomes long, and the residence time of the resin is increased. Moreover, shearing stress of the gear pump part may cut the molecular chain. Therefore, cautions are needed.

A preferable residence time of the resin from a time when the resin enters the extruder from the feed opening to a time when the resin is discharged out of the die is not less than 2 minutes and not more than 60 minutes, more preferably not less than 3 minutes and not more than 40 minutes, and still more preferably not less than 4 minutes and not more than 30 minutes.

When a polymer for bearing circulation in the gear pump does not flow smoothly, sealing between a drive unit and a bearing part by the polymer worsens, causing a problem that fluctuation of measurement and that of extrusion pressure when feeding a liquid are increased. Therefore, it is necessary to design the gear pump (particularly, a clearance thereof) in accordance with the melt viscosity of the cellulose acylate resin. Moreover, in some cases, the stagnation portion of the gear pump causes deterioration of the cellulose acylate resin. Accordingly, a structure that can minimize stagnation is preferable. A polymer tube and an adapter that connect the extruder with the gear pump or the gear pump with the die, etc. also need a structure that can minimize stagnation. In addition, in order to stabilize the extrusion pressure of the cellulose acylate resin having large temperature dependence on the melt viscosity, preferably, fluctuation of the temperature can be minimized. Generally, a band heater of inexpensive equipment cost is often used to heat the polymer tube. However, more preferably, an aluminum cast heater having less temperature change is used. Furthermore, in order to stabilize discharge pressure within the extruder as mentioned above, preferably, a barrel of the extruder is heated for melting by a heater divided into not less than 3 and not more than 20.

### (v) Die

The cellulose acylate resin is molten by the extruder configured as mentioned above, and the molten resin is continuously fed into the die through the filter and the gear pump when necessary. The die may be any type of T dies, fishtail dies, and hanger court dies, which are generally used, as long as the die is designed so as to minimize stagnation of the molten resin within the die. Moreover, a static mixer for improving uniformity of the resin temperature may be provided immediately before the T die. The clearance of an outlet portion of the T die is generally 1.0 to 5.0 times the film thickness, preferably 1.2 to 3 times, and more preferably 1.3 to 2 times. When a lip clearance is less than 1.0 time the film thickness, it is difficult to obtain a sheet in an excellent surface state by film forming. The large lip clearance exceeding 5.0 times the film thickness is not preferable because thickness accuracy of the sheet is reduced. The die is very important equipment to determine the thickness accuracy of the film, and a die enabling severe control of thickness adjustment is preferable. Usually, the thickness adjustment can be performed at an interval of 40 to 50 mm. However, a type allowing the thickness adjustment of the film preferably at an interval of not more than 35 mm and more preferably at an interval of not more than 25 mm. Moreover, the cellulose acylate resin has high dependence of the temperature on the melt viscosity and on a shearing rate. Accordingly, it is important to design the die so as to minimize unevenness of the temperature and that of the flow rate in the width direction. An automatic thickness adjusting die that calculates a thickness deviation by measuring the film thickness downstream and feeding back the result to thickness adjustment of the die is also effective for reduction in fluctuation of the film thickness in long-term continuous production.

### (vi) Casting

The molten resin extruded into a sheet-like form from the die by the above-mentioned method is extruded onto a cooling drum in a sheet-like form. At this time, thickness unevenness in the width direction can be adjusted by adjusting an interval of the lip of the die.

At this time, it is necessary to cool and solidify the molten resin while the molten resin is sandwiched by a pair of metal rollers having a surface property such that an arithmetic mean height Ra is not more than 100 nm. When using the cooling roller having a surface property such that the arithmetic mean height Ra is more than 100 nm, it is not preferable because transparency of the film is reduced. The arithmetic mean height Ra is preferably not more than 50 nm, and more preferably 25 nm.

A temperature of the cooling drum is preferably not less than 60° C. and not more than 160° C., more preferably not less than 70° C. and not more than 150° C., and still more preferably not less than 80° C. and not more than 140° C. Subsequently, the sheet is peeled off from the cooling drum, and taken up through a taking-over roller (nip roller). A take-up velocity is preferably not less than 10 m/min. and not more than 100 m/min., more preferably not less than 15 m/min. and not more than 80 m/min., and still more preferably not less than 20 m/min. and not more than 70 m/min.

A width of the film formed is not less than 0.7 m and not more than 5 m, more preferably not less than 1 m and not more than 4 m, and still more preferably not less than 1.3 m and not more than 3 m. A thickness of an unstretched film thus obtained is preferably not less than 30 μm and not more than 400 μm, more preferably not less than 40 μm and not more than 300 μm, and still more preferably not less than 50 μm and not more than 200 μm.

When the so-called touch roll method is used, the surface of the touch roll may be made of a resin such as rubber, Teflon (registered trademark), etc. Alternatively, a metal roller may be used. It is also possible to use a roller as called a flexible roller in which a metal roller has a thinner thickness, and the roller surface thereof is slightly depressed by a pressure when touching so that a pressed area is increased.

A temperature of the touch roll is preferably not less than 60° C. and not more than 160° C., more preferably not less than 70° C. and not more than 150° C., still more preferably not less than 80° C. and not more than 140° C.

(vii) Take-up

Preferably, the thus-obtained sheet is taken up after both sides of the sheet are trimmed. The trimmed portion may be reused as a raw material for a film of the same kind or as a raw material for a film of a different kind after being crushed or, when necessary, subjected to granulation, depolymerization, re-polymerization, and the like. Any type of a trimming cutter, such as a rotary cutter, a shear blade, and a knife, may be used. For the material of the trimming cutter, either of carbon steel and stainless steel may be used. Generally, use of superhard blades and ceramic blades is preferable because those blades have longer life span, and less cutting powders is produced.

It is also preferable from a viewpoint of prevention of damages that a laminate film is attached onto at least one side of the sheet before take-up. A preferable take-up tension is not less than 1 kg/m width and not more than 50 kg/width, more preferably not less than 2 kg/m width and not more than 40 kg/width, and still more preferably not less than 3 kg/m width and not more than 20 kg/width. When the take-up tension is smaller than 1 kg/m width, it is difficult to take up the film uniformly. On the other hand, when the take-up tension exceeds 50 kg/width, the film is taken up too tight, an appearance of a roll deteriorates. Additionally, a bump portion of the film is stretched for a creep phenomenon to cause a wave in the film, or extension of the film causes residual birefringence. Therefore, it is not preferable. Preferably, the take-up tension is detected by a tension control in the course of the line, and the sheet is taken up while being controlled so as to have a constant take-up tension. When there is a difference in the film temperature depending on a place of the film forming line, the length of the film may be slightly changed by thermal expansion. Accordingly, a stretch ratio between the nip rolls is needed to be adjusted unless the tension not less than a predetermined tension is applied to the film in the course of the line.

The sheet can also be taken up at a constant tension by controlling the take-up tension by the tension control. However, more preferably, the take-up tension is reduced in a tapered manner in accordance with a diameter of the sheet taken up so as to provide a proper take-up tension. Usually, the tension is gradually reduced as the diameter of the roll becomes larger. However, it may be preferable that the tension is gradually increased as the diameter of the roll becomes larger.

(viii) Physical Properties of the Unstretched Cellulose Acylate Film

In the unstretched cellulose acylate film thus obtained, when the longitudinal direction of the film is the slow axis, Re=0 to 20 nm and Rth=0 to 20 nm are preferable. Re and Rth respectively designate the in-plane retardation and the thickness-direction retardation. Re is measured by entering light in a normal direction of the film using a KOBRA 21ADH (made by Oji Sceientific Instruments). Rth is calculated based on retardation values measured from three directions, namely, the above-mentioned Re and retardations measured by entering the light from a direction inclined +40° and a direction inclined −40° to the normal direction of the film when the in-plane slow axis is an inclined axis (axis of rotation). Moreover, preferably, an angle θ that the direction of film forming (the longitudinal direction) and the slow axis of Re in the film make is closer to 0°, +90°, or −90°.

Total light transmittance is preferably 90% to 100%, more preferably 91% to 99%, and still more preferably 92% to 98%. A preferable haze is 0 to 1%, more preferably 0 to 0.8%, and still more preferably 0 to 0.6%.

Both in the longitudinal direction and in the width direction, thickness unevenness is preferably not less than 0% and not more than 4%, more preferably not less than 0% and not more than 3%, and still more preferably not less than 0% and not more than 2%.

A tension modulus of elasticity is preferably not less than 1.5 kN/mm² and not more than 3.5 kN/mm², more preferably not less than 1.7 kN/mm² and not more than 2.8 kN/mm², and still more preferably not less than 1.8 kN/mm² and not more than 2.6 kN/mm².

An elongation at break is preferably not less than 3% and not more than 100%, more preferably not less than 5% and not more than 80%, and preferably not less than 8% and not more than 50%.

Tg (Tg of the film, i.e., Tg of a mixture of cellulose acylate and additives is meant) is preferably not less than 95° C. and not more than 145° C., more preferably not less than 100° and not more than 140° C., and still more preferably not less than 105° C. and not more than 135° C.

Both in the lengthwise direction and the transverse direction, thermal dimensional change at 80° C. one day is preferably not less than 0% and within ±1% (inclusive), more preferably not less than 0% and within ±0.5% (inclusive), and still more preferably not less than 0% and within ±0.3% (inclusive).

Water permeability at 40° C. and 90% rh is preferably not less than 300 g/m² per day and not more than 1000 g/m² per day, more preferably not less than 400 g/m² per day and not more than 900 g/m² per day, and still more preferably not less than 500 g/m² per day and not more than 800 g/m² per day.

An equilibrium moisture content at 25° C. and 80% rh is preferably not less than 1 wt % and not more than 4 wt %, more preferably not less than 1.2 wt % and not more than 3 wt %, and still more preferably not less than 1.5 wt % and not more than 2.5 wt %.

### (8) Stretch

The film formed by the above-mentioned method may be stretched. Thereby, Re and Rth can be controlled.

Preferably, stretching is performed at not less than Tg and not more than Tg+50° C., more preferably not less than Tg+3° C. and not more than Tg+30° C., and still more preferably not less than Tg+5° C. and not more than Tg+20° C. A preferable stretch ratio is at least not less than 1% and not more than 300% in one direction, more preferably not less than 2% and not more than 250%, and still more preferably not less than 3% and not more than 200%. Although the film may be stretched uniformly both in the lengthwise direction and the transverse direction, uneven stretching by making one stretch ratio larger than the other is more preferable. Any of the lengthwise (MD) stretch ratio and the transverse (TD) stretch ratio may be increased. However, the smaller stretch ratio is preferably not less than 1% and not more than 30%, more preferably not less than 2% and not more than 25%, and still more preferably not less than 3% and not more than 20%. The larger stretch ratio is not less than 30% and not more than 300%, more preferably not less than 35% and not more than 200%, and still more preferably not less than 40% and not more than 150%. The stretching mentioned above may be performed at one stage, or may be performed at a multi stage. The stretch ratio here is calculated using the following equation.

Stretch ratio (%)=100×{(length after stretching)−(length before stretching)}/(length before stretching)

Such stretching may be stretching in the longitudinal direction (lengthwise stretching) by using not less than two pairs of nip rolls whose rotational speed of the outlet side is faster, or may be stretching (transverse stretching) by holding both sides of the film by a chuck and stretching the film in a perpendicular direction (a direction perpendicular to the longitudinal direction). A simultaneous biaxial stretching method described in Japanese Patent Application Laid-Open Nos. 2000-37772, 2001-113591, and 2002-103445 may be used.

In the case of the lengthwise stretching, free control of a ratio of Re and Rth can be achieved also by controlling a value (aspect ratio) obtained by dividing between the nip rolls by the film width. That is, the Rth/Re ratio can be increased by making the aspect ratio smaller. Moreover, Re and Rth can be controlled in combination with the lengthwise stretching and the transverse stretching. That is, Re can be made smaller when a difference between the lengthwise stretch ratio and the transverse draw ratio is made smaller, and Re can be made larger when the difference is made larger.

Preferably, Re and Rth of the cellulose acylate film thus stretched satisfy the following equations.

Rth≧Re

500≧Re≧0

500≧Rth≧30.

More preferably,

Rth≧Re×1.1

150≧Re≧10

400≧Rth≧50.

Still more preferably,

Rth≧Re≧1.2

100≧Re≧20

350≧Rth≧80.

Moreover, preferably, the angle θ that the direction of film forming (the longitudinal direction) and the slow axis of Re in the film make is closer to 0°, +90°, or −90°. Namely, in the case of the lengthwise stretching, the angle θ closer to 0° is preferable, and preferably 0±3°, more preferably 0±2°, and still more preferably 0±1°. In the case of the transverse stretching, the angle θ is preferably 90±3° or −90±3°, more preferably 90±2° or −90±2°, and still more preferably 90±1° or −90±1°.

In both the longitudinal direction and the width direction, thickness unevenness of the cellulose acylate film after stretching is preferably not less than 0% and not more than 3%, more preferably not less than 0% and not more than 2%, and still more preferably not less than 0% and not more than 1%.

Physical properties of the stretched cellulose acylate film have the following preferable ranges.

A tension modulus of elasticity is preferably not less than 1.5 kN/mm² and less than 3.0 kN/mm², more preferably not less than 1.7 kN/mm² and not more than 2.8 kN/mm², and still more preferably not less than 1.8 kN/mm² and not more than 2.6 kN/mm².

An elongation at break is preferably not less than 3% and not more than 100%, more preferably not less than 5% and not more than 80%, and preferably not less than 8% and not more than 50%.

Tg (Tg of the film, i.e., Tg of a mixture of cellulose acylate and additives is meant) is preferably not less than 95° C. and not more than 145° C., more preferably not less than 100° C. and not more than 140° C., and still more preferably not less than 105° C. and not more than 135° C.

Both in the lengthwise direction and the transverse direction, thermal dimensional change at 80° C. one day is preferably not less than 0% and within ±1% (inclusive), more preferably not less than 0% and within ±0.5% (inclusive), and still more preferably not less than 0% and within ±0.3% (inclusive).

Water permeability at 40° C. and 90% is preferably not less than 300 g/m² per day and not more than 1000 g/m² per day, more preferably not less than 400 g/m² per day and not more than 900 g/m² per day, and still more preferably not less than 500 g/m² per day and not more than 800 g/m² per day.

An equilibrium moisture content at 25° C. and 80% rh is preferably not less than 1 wt % and not more than 4 wt %, more preferably not less than 1.2 wt % and not more than 3 wt %, and still more preferably not less than 1.5 wt % and not more than 2.5 wt %.

A thickness is preferably not less than 30 μm and not more than 200 μm, more preferably not less than 40 μm and not more than 180 μm, and still more preferably not less than 50 μm and not more than 150 μm.

A haze is not less than 0% and not more than 2.0%, more preferably not less than 0% and not more than 1.5%, and still more preferably not less than 0% and not more than 1%.

Total light transmittance is preferably 90% to 100%, more preferably 91% to 99%, and still more preferably 92% to 98%.

### (9) Surface Treatment

By performing surface treatment, the unstretched and stretched cellulose acylate films can obtain improved adhesion to each functional layer (for example, an undercoat layer and a back layer). For example, glow discharge treatment, UV irradiation treatment, corona treatment, flame treatment, acid or alkaline treatment can be used. The glow discharge treatment here may be a treatment using a plasma having a low temperature generated under a gas at a low pressure of 10⁻³ to 20 Torr. Further, plasma treatment under atmospheric pressure is also preferable. A plasma excited gas means a gas plasma excited on the above-mentioned conditions, and includes argon, helium, neon, krypton, xenon, nitrogen, carbon dioxide, chlorofluocarbon such as tetrafluoromethane, a mixture of those, etc. These details are described on pages 30 to 32 of Japan Institute of Invention and Innovation (Kokai Giho Ko-Gi No. 2001-1745, published on Mar. 15, 2001 by the Japan Institution of Invention and Innovation). In the plasma treatment in atmospheric pressure that attracts attention in recent years, for example, irradiation energy of 20 to 500 Kgy under 10 to 1000 Key is used. Irradiation energy of 20 to 300 Kgy under 30 to 500 Key is more preferably used. Among these treatments, alkali saponification treatment is particularly preferable, and it is very effective as the surface treatment for the cellulose acylate film. Specifically, the surface treatments described in Japanese Patent Application Laid-Open Nos. 2003-3266, 2003-229299, 2004-322928, and 2005-76088 can be used.

The alkali saponification treatment may be dipping into a saponification liquid, or may be application of the saponification liquid. In the case of dipping method, an aqueous solution of NaOH, KOH, etc. of pH 10 to 14 passes through a tank heated at 20° C. to 80° for 0.1 minutes to 10 minutes. Subsequently, the surface treatment can be achieved by neutralizing, rinsing, and drying the film.

In the case of the coating method, a dip coating method, a curtain coating method, an extrusion coating method, a bar coating method, and an E-type coating method can be used. A solvent for an alkali saponification treatment coating liquid to be selected is preferably a solvent that has excellent wettability to coat a transparent base with the saponification liquid, and keeps a surface state good without the saponification liquid solvent forming projections and depressions on the surface of the transparent base. Specifically, alcoholic solvents are preferable, and isopropyl alcohol is particularly preferable. An aqueous solution of a surfactant can also be used as the solvent. As alkalis of the alkali saponification coating liquid, those that dissolve in the above-mentioned solvent are preferable, and KOH and NaOH are more preferable. The pH of the saponification coating liquid is preferably not less than 10, and more preferably not less than 12. A reaction condition at the time of alkali saponification is at room temperature and preferably not less than 1 seconds and not more than 5 minutes, more preferably not less than 5 seconds and not more than 5 minutes, and particularly preferably not less than 20 seconds and not more than 3 minutes. Preferably, after the alkali saponification reaction, the surface coated with the saponification liquid was washed by water or acid, and then washed by water. In addition, the saponification treatment by coating and application of an oriented film mentioned later can be performed continuously. Therefore, the number of steps can be reduced. Specifically, these saponification methods include those described in Japanese Patent Application Laid-Open No. 2002-82226 and WO 02/46809, for example.

It is also preferable that an undercoat layer is provided for adhesion to the functional layer. This layer may be applied after the above-mentioned surface treatment, or may be applied without the surface treatment. Details of the undercoat layer are described on page 32 of Japan Institute of Invention and Innovation, Kokai Giho (Ko-Gi No. 2001-1745, published on Mar. 15, 2001 by the Japan Institution of Invention and Innovation).

These surface treatment and undercoat step can also be incorporated into the end of the film forming step, can also be performed alone, or can also be performed in a step of providing the functional layer.

### (10) Provision of a Functional Layer

Preferably, the unstretched or stretched cellulose acylate film according to the present invention is combined with the functional layer described in detail on pages 32 to 45 of Japan Institute of Invention and Innovation, Kokai Giho (Ko-Gi No. 2001-1745, published on Mar. 15, 2001 by the Japan Institution of Invention and Innovation). Among them, a polarizing layer (polarizing plate), an optical compensation layer (optical compensation film), an antireflective layer (antireflective film), and a hard-coat layer are preferably provided.

### (i) Provision of a Polarizing Layer (Production of a Polarizing Plate)

### [Material Used for the Polarizing Layer]

At present, a commercially available polarizing layer is usually produced by immersing a stretched polymer into a solution of iodine or dichroism pigment in a bath to permeate iodine or dichroism pigment into a binder. A coated type polarizing film represented by Optiva Inc. can also be used as a polarizing film. Iodine and dichroism pigment in the polarizing film generate deflection performance by orientation in the binder. As the dichroism pigment, azo based pigments, stilbene based pigments, pyrazolone based pigments, triphenylmethane based pigments, quinoline based pigments, oxazine based pigments, thiazine based pigments, and anthraquinone based pigments are used. The dichroism pigment is preferably water soluble. The dichroism pigment preferably has a hydrophilic substituent (example, sulfo, amino, hydroxyl). For example, compounds described on page 58 of Japan Institute of Invention and Innovation, Kokai Giho Ko-Gi No. 2001-1745 (published on Mar. 15, 2001 by the Japan Institution of Invention and Innovation) are included.

As the binder for the polarizing film, either of polymers that can be crosslinked by itself and polymers that can be crosslinked by a crosslinking agent can be used. A plurality of combinations of these can be used. The binder includes methacrylate based copolymers, styrene based copolymers, polyolefines, polyvinyl alcohols, and denatured polyvinyl alcohols, poly(N-methylolacrylamide), polyester, polyimide, vinyl acetate copolymers, carboxymethyl cellulose, polycarbonate, etc, for example, described in paragraph number [0022] of Japanese Patent Application Laid-Open No. 08-338913. Water-soluble polymers (for example, poly(N-methylolacrylamide), carboxymethyl cellulose, gelatin, polyvinyl alcohol, denatured polyvinyl alcohol) are preferable. Gelatin, polyvinyl alcohol, and denatured polyvinyl alcohol are more preferable, and polyvinyl alcohol and denatured polyvinyl alcohol are most preferable. Particularly preferably, two kinds of polyvinyl alcohols or denatured polyvinyl alcohols having a different polymerization degree are used together. A saponification degree of polyvinyl alcohol is preferably 70 to 100%, and more preferably 80 to 100%. A polymerization degree of polyvinyl alcohol is preferably 100 to 5000. Denatured polyvinyl alcohols are described in Japanese Patent Application Laid-Open Nos. 08-338913, 09-152509, and 09-316127. Not less than two kinds of polyvinyl alcohol and denatured polyvinyl alcohols may be use together.

A lower limit of a thickness of the binder is preferably 10 μm. From a viewpoint of light leakage in a liquid crystal display, as an upper limit of thereof, a smaller thickness is more preferable. The thickness is preferably not more than a thickness of a polarizing plate commercially available now (approximately 30 μm). The thickness of not more than 25 μm is preferable, and that of not more than 20 μm is more preferable.

The binder of the polarizing film may be crosslinked. A polymer and a monomer both having a crosslinkable functional group may be mixed with the binder, or a crosslinkable functional group may be given to the binder polymer itself. Light, heat, or pH change can cause crosslinking to form a binder having a crosslinked structure. A crosslinking agent is described in U.S. Reissue Pat. No. Re 23297. Boron compounds (for example, boric acid, borax) can also be used as the crosslinking agent. An amount of addition of the crosslinking agent for the binder is preferably 0.1 to 20 mass % to the binder. Orientation properties of a polarizing element and resistance against humidity and heat of the polarizing film are improved.

Even after the crosslinking reaction is completed, an amount of an unreacted crosslinking agent is preferably not more than 1.0 mass %, and more preferably not more than 0.5 mass %. This improves weatherability.

### [Stretching of the Polarizing Film]

Preferably, the polarizing film is dyed by iodine or a dichromatic dye after stretching of the polarizing film (a stretching method) or rubbing thereof (a rubbing method).

In the case of the stretching method, the stretch ratio is preferably 2.5 to 30.0 times, and more preferably 3.0 to 10.0 times. Stretching can be performed by dry stretching in the air. Alternatively, wet stretching in the state where the polarizing film is immersed into water may be performed. A stretch ratio of dry stretching is preferably 2.5 to 5.0 times, and a stretch ratio of wet stretching is preferably 3.0 to 10.0 times. Stretching may be performed parallel to the MD direction (parallel stretching), or may be performed in an inclined direction (inclined stretching). The above-mentioned stretching may be performed at one time or may be performed several times. By stretching several times, the polarizing film can be stretched more uniformly when the stretch ratio is larger. More preferable is inclined stretching in which the polarizing film is stretched inclined by 10° to 80° in the inclined direction.

### (I) The Parallel Stretching Method

A PVA film is swelled prior to stretching. A degree of swelling is 1.2 to 2.0 times (in a ratio of a mass before swelling and that after swelling). Then, while the PVA film is continuously conveyed through a guide roller or the like, the PVA film is stretched at a bath temperature of 15 to 50° C., preferably 17 to 40° C. within a bath of a water based medium or a dyeing bath in which a dichroism substance is dissolved. Stretching can be achieved by holding the PVA film with two pairs of nip rolls and making a conveying velocity of the nip rolls at a rear stage larger than that at a front stage. A stretch ratio is on the basis of a ratio of a length after stretching to an initial length (hereinafter the same). From a viewpoint of an operation effect, a preferable stretch ratio is 1.2 to 3.5 times, and preferably 1.5 to 3.0 times. Subsequently, the PVA film is dried at 50° C. to 90° C. to obtain the polarizing film.

### (II) The Inclined Stretching Method

A method described in Japanese Patent Application Laid-Open No. 2002-86554 can be used in which stretching in an inclined direction is performed by using a tenter projected in an inclined direction. Because this stretching is performed in the air, water is needed to be contained in the PVA film in advance to facilitate stretching. A preferable moisture content is not less than 5% and not more than 100%. A temperature of stretching is preferably not less than 40° C. and not more than 90° C. A humidity during stretching is preferably not less than 50% rh and not more than 100% rh.

An absorption axis of the thus-obtained polarizing film is preferably from 10° to 80°, more preferably from 30° to 60°, and still more preferably and substantially 45° (from 40° to 50°.

### [Lamination]

The stretched or unstretched cellulose acylate film after the above-mentioned saponification and the polarizing layer prepared by stretching are laminated to prepare a polarizing plate. Although a direction of lamination is not limited in particular, lamination is preferably performed so that a casting axis direction of the cellulose acylate film and a stretching axis direction of the polarizing plate may make an angle of 0°, 45°, or 90°.

Although an adhesive for lamination is not limited in particular, PVA based resins (including denatured PVAs having an acetoacetyl group, a sulfonic group, a carboxyl group, an oxy alkylene group, etc.), an aqueous solution of boron compounds, and the like are included. PVA based resins are preferable among them. A thickness of an adhesive layer is preferably 0.01 to 10 μm after drying, and particularly preferably 0.05 to 5 μm.

A configuration of layers to be laminated includes the following.

1) A/P/A

2) A/P/B

3) A/P/T

4) B/P/B

5) B/P/T

A designates the unstretched film of the present invention and B designates the stretched film of the present invention, T designates a cellulose triacetate film (FUJITAC), and P designates the polarizing layer. In the case of the configuration in 1) and 2), A and B may be cellulose acetate having the same composition or that having a different composition. In the case of the configuration in 4), B may be cellulose acetate having the same composition or that having a different composition, and the stretch ratio thereof may be the same and may be different. When the laminated layers are incorporated and used in a liquid crystal display, both surfaces of the laminated layers may be used as a liquid crystal surface. However, in the case of the configurations 2) and 5), more preferably, B is used as the liquid crystal surface side.

In the case of incorporation into the liquid crystal display, usually, a substrate including liquid crystal is disposed between two polarizing plates. However, 1) to 5) of the present invention and a normal polarizing plate (T/P/T) can be freely combined. However, preferably, a transparent hard-coat layer, an anti-glare layer, an antireflective layer, etc. are provided on the outermost surface film on the displaying side of the liquid crystal display, and the layers mentioned later can be used as the above-mentioned layers.

In the thus-obtained polarizing plate, higher light transmittance is preferable, and a higher degree of polarization is also preferable. The transmittance of the polarizing plate is preferably within the range of 30 to 50% in light of a wavelength of 550 nm, more preferably within the range of 35 to 50%, and most preferably within the range of 40 to 50%. The degree of polarization is preferably within the range of 90 to 100% in light of a wavelength of 550 nm, more preferably within the range of 95 to 100%, and still more preferably within the range of 99 to 100%.

Furthermore, the polarizing plate thus obtained can be laminated with a λ/4 plate to generate a circular polarized light. In this case, lamination is performed so that a slow axis of λ/4 and an absorption axis of the polarizing plate may make an angle of 45°. Although λ/4 is not particularly limited at this time, more preferably, λ/4 having such wavelength dependency that the retardation becomes smaller as the wavelength is lower is more preferable. Still more preferably, a polarizing film having an absorption axis inclined 20° to 70° in the longitudinal direction and a λ/4 plate made of an optical anisotropy layer made of a liquid crystalline compound are used.

A protection film may be laminated onto one surface of these polarizing plates, and a separate film may be laminated onto the opposite surface. The protection film and the separate film are used in order to protect the polarizing plate during product inspection at the time of shipping the polarizing plate.

### (ii) Provision of the Optical Compensation Layer (Production of the Optical Compensation Film)

The optical anisotropy layer is for compensating for a liquid crystal compound in a liquid crystal cell in black displaying of the liquid crystal display. The optical anisotropy layer is formed by forming an oriented film on the stretched or unstretched cellulose acylate film, and further providing an optical anisotropy layer.

### [Oriented Film]

An oriented film is provided on the stretched or unstretched cellulose acylate film subjected to the above-mentioned surface treatment. This film has a function to determine an orientation direction of liquid crystalline molecules. However, the oriented film plays the role and the oriented film is not always essential as a component of the present invention when the liquid crystalline compound is fixed in the oriented state after orientation. In other words, it is also possible to transfer only the optical anisotropy layer on the oriented film having the fixed oriented state onto a polarizer to produce the polarizing plate in the present invention.

The oriented film can be provided by methods as rubbing treatment of an organic compound (preferably, a polymer), oblique angle deposition of an inorganic compound, formation of a layer having micro grooves, or accumulation of organic compound (example, m-tricosanoic acid, dioctadecyl methylammonium chloride, stearyl acid methyl) by a Langmuir-Blodgett method (LB film). Further, an oriented film whose orientation function is caused by giving an electric field or a magnetic field, or irradiating with light is also known.

The oriented film is preferably formed by rubbing treatment of a polymer. In principle, the polymer used for the oriented film has a molecular structure having a function to orient the liquid crystalline molecules.

In the present invention, in addition to the function to orient the liquid crystalline molecules, preferably, a side chain having a crosslinkable functional group (for example, double bond) is bonded to a principal chain, or a crosslinkable functional group having the function to orient the liquid crystalline molecules is introduced into the side chain.

As the polymer used for the oriented film, polymers that can be crosslinked by itself or polymers crosslinked by a crosslinking agent can be used. Further, a plurality of combinations of these can be used. Examples of the polymer include methacrylate based copolymers, styrene based copolymers, polyolefines, polyvinyl alcohol and denatured polyvinyl alcohols, poly(N-methylolacrylamide), polyesters, polyimides, vinyl acetate copolymers, carboxymethyl cellulose, polycarbonate, etc., for example, which are described in paragraph number [0022] of Japanese Patent Application Laid-Open No. 08-338913. A silane coupling agent can be used as the polymer. Water-soluble polymers (for example, poly(N-methylolacrylamide), carboxymethyl cellulose, gelatin, polyvinyl alcohol, denatured polyvinyl alcohols) are preferable. Gelatin, polyvinyl alcohol, and denatured polyvinyl alcohols are more preferable, and polyvinyl alcohol and denatured polyvinyl alcohols are most preferable. Particularly preferably, two kinds of polyvinyl alcohol and denatured polyvinyl alcohols having a different polymerization degree are used together. A saponification degree of polyvinyl alcohol is preferably 70 to 100%, and more preferably 80 to 100%. A polymerization degree of polyvinyl alcohol is preferably 100 to 5000.

The side chain having the function to orient the liquid crystalline molecules usually has a hydrophobic group as a functional group. A specific kind of the functional group is determined according to a kind of liquid crystalline molecules and the oriented state needed. For example, a denaturing group for a denatured polyvinyl alcohol can be introduced by copolymerization denaturation, chain transfer denaturation, or block polymerization denaturation. Examples of the denaturing group include hydrophilic groups (carboxylic acid group, sulfonic group, phosphonic acid group, amino group, ammonium group, amide group, thiol group, etc.), hydrocarbon groups having carbon atoms of 10 to 100, hydrocarbon groups substituted by a fluorine atom, thioether groups, polymerizable groups (unsaturated polymerizable groups, epoxy groups, aziridinyl groups, etc.), alkoxy silyl groups (trialkoxy, dialkoxy, monoalkoxy), etc. Specific examples of these denatured polyvinyl alcohol compounds include those described, for example, in paragraph numbers [0022] to [0145] of Japanese Patent Application Laid-Open No. 2000-155216 and in paragraph numbers [0018] to [0022] of Japanese Patent Application Laid-Open No. 2002-62426.

When the side chain having a crosslinkable functional group is bonded to a principal chain, or a crosslinkable functional group having the function to orient the liquid crystalline molecules is introduced into the side chain, the polymer of the oriented film and a polyfunctional monomer included in the optical anisotropy layer can be copolymerized. As a result, strong covalent bonding is formed between the polyfunctional monomers, between the oriented film polymers, and between the polyfunctional monomer and the oriented film polymer. Accordingly, strength of the optical compensation film can be remarkably improved by introducing a crosslinkable functional group into the oriented film polymer.

Preferably, the crosslinkable functional group of the oriented film polymer includes a polymerizable group similarly to the case of the polyfunctional monomer. Specifically, the crosslinkable functional group includes those described in paragraph numbers [0080] to [0100] of Japanese Patent Application Laid-Open No. 2000-155216, for example. The oriented film polymer can also be crosslinked using a crosslinking agent instead of the above-mentioned crosslinkable functional group.

The crosslinking agent includes aldehydes, N-methylol compounds, dioxane derivatives, compounds that act by activating a carboxyl group, active vinyl compounds, active halogen compounds, isoxazole, and dialdehyde starch. Not less than two kinds of the crosslinking agents may be used together. Specifically, the crosslinking agent includes those described in paragraph numbers [0023] to [0024] of Japanese Patent Application Laid-Open No. 2002-62426, for example. Highly reactive aldehydes, especially, glutaraldehyde is preferable.

An amount of addition of the crosslinking agent is preferably 0.1 to 20 mass % to the polymer, and more preferably 0.5 to 15 mass %. An amount of the unreacted crosslinking agent that remains in the oriented film is preferably not more than 1.0 mass % to the polymer, and more preferably not more than 0.5 mass %. Sufficient durability without reticulation is obtained by adjusting in this way even when the oriented film is used in the liquid crystal display for a long time or left under an atmosphere of high humidity and high temperature for a long time.

The oriented film can be basically formed by application of the above-mentioned polymer as an oriented film formation material onto a transparent base including the crosslinking agent, then, drying by heating (crosslinking), and the rubbing treatment. As mentioned above, the crosslinking reaction may be performed at any stage after applying the polymer onto the transparent base. When a water soluble polymer as polyvinyl alcohol is used as the oriented film formation material, a preferable coating liquid is a mixed solvent of an organic solvent having anti-foaming action (for example, methanol) and water. The ratio of water:methanol is preferably 0:100 to 99:1 in a mass ration, and more preferably 0:100 to 91:9. Thereby, bubbles to be produced are suppressed so that defects in the oriented film and also the layer surface of the optical anisotropic layer are reduced remarkably.

A method for applying the oriented film is preferably a spin coating method, a dip coating method, a curtain coating method, an extrusion coating method, a rod coating method, or a roll coating method. Particularly, the rod coating method is preferable. Moreover, a thickness after drying is preferably 0.1 to 10 μm. Drying by heating can be performed at 20° C. to 110° C. In order to form sufficient crosslinking, a temperature of 60° C. to 100° C. is preferable, and that of 80° C. to 100° C. is particularly preferable. A drying time can be for 1 minute to 36 hours, and is preferably for 1 minute to 30 minutes. Preferably, a pH is also set at an optimal value for the crosslinking agent to be used, and is pH of 4.5 to 5.5 and particularly preferably 5 when glutaraldehyde is used.

The oriented film is provided on the stretched or unstretched cellulose acylate film or the above-mentioned undercoat layer. The oriented film can be obtained by crosslinking the polymer layer as mentioned above and performing the rubbing treatment on the surface thereof.

As the rubbing treatment, a treatment method widely employed as a liquid crystal orientation treatment step for the LCD can be applied. That is, a method for obtaining orientation can be used by rubbing the surface of the oriented film in a certain direction using paper, gauze, felt, rubber, nylon, polyester fiber, or the like. The rubbing treatment is generally performed by rubbing about several times using a cloth or the like in which fibers having a uniform length and thickness are transplanted uniformly.

In the case of industrial operation, rubbing is achieved by contacting a rotating rubbing roller with a film while a polarizing layer is conveyed. Preferably, circularity of the rubbing roller, cylindricity, and deflection (eccentricity) are not more than 30 μm. A lap angle of the film with respect to the rubbing roller is preferably 0.1 to 90°. Note that a stable rubbing treatment can also be obtained by winding the film by an angle of not less than 360° as described in Japanese Patent Application Laid-Open No. 08-160430. A conveying velocity of the film is preferably 1 to 100 m/min. Preferably, an appropriate rubbing angle is selected within the range of the rubbing angle of 0 to 60°. When the film is used for the liquid crystal display, the rubbing angle is preferably 40 to 50°. Particularly, a rubbing angle of 45° is preferable.

A thickness of the thus-obtained oriented film is preferably within the range of 0.1 to 10 μm.

Then, the liquid crystalline molecules of the optical anisotropy layer are oriented on the oriented film. Subsequently, when necessary, the oriented film polymer is reacted with the polyfunctional monomer included in the optical anisotropy layer, or the oriented film polymer is crosslinked using the crosslinking agent.

The liquid crystalline molecules used for the optical anisotropy layer include a rod-like liquid crystalline molecule and a discotic liquid crystalline molecule. The rod-like liquid crystalline molecule and the discotic liquid crystalline molecule may be a liquid crystal polymer or a low molecular liquid crystal, and further include a low molecular liquid crystal that is crosslinked not to show liquid crystallinity any longer.

### [Rod-like Liquid Crystalline Molecule]

As the rod-like liquid crystalline molecule, azomethines, azoxys, cyano biphenyls, cyanophenyl esters, benzoic esters, cyclohexane carboxylic acid phenyl esters, cyanophenyl cyclohexanes, cyano substituted phenyl pyrimidines, alkoxy substituted phenyl pyrimidines, phenyldioxanes, tolans, and alkenyl cyclohexyl benzonitriles are preferably used.

The rod-like liquid crystalline molecule also includes a metal complex. Moreover, a liquid crystal polymer repeatedly including a rod-like liquid crystalline molecule in units can also be used as the rod-like liquid crystalline molecule. In other words, the rod-like liquid crystalline molecule may be bonded to a (liquid crystal) polymer.

The rod-like liquid crystalline molecule has been described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Ekisho Debaisu Handobukku (Handbook of Liquid Crystal Devices), edited by 142th Committee of Japan Society for the Promotion of Science, Chapter 3.

A birefringence of the rod-like liquid crystalline molecule is preferably within the range of 0.001 to 0.7.

Preferably, the rod-like liquid crystalline molecule has a polymerizable group in order to fix the oriented state. The polymerizable group is preferably a radically polymerizable unsaturated group or a cationically polymerizable group, and specifically includes a polymerizable group and a polymerizable liquid crystal compound described in paragraph numbers [0064] to [0086] of Japanese Patent Application Laid-Open No. 2002-62427, for example.

### [Discotic Liquid Crystalline Molecule]

The discotic (discotic) liquid crystalline molecule includes: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

The discotic liquid crystalline molecule also includes a compound showing liquid crystallinity and having a structure in which a linear alkyl group, an alkoxy group, and a substituted benzoyloxy group are substituted as a side chain of a mother nucleus radially to the mother nucleus at a center of a molecule. Preferably, the molecule or an aggregate of the molecules are a compound that is rotationally symmetric and can provide a constant orientation. In the optical anisotropy layer formed of the discotic liquid crystalline molecule, the compound eventually included in the optical anisotropy layer does not need to be the discotic liquid crystalline molecule. For example, the optical anisotropy layer also may include a compound made of a low molecular discotic liquid crystalline molecule that has a group reactive with heat or light and is polymerized or crosslinked by the reaction of the group with heat or light to obtain the high molecular weight so that the liquid crystallinity is lost. A preferable example of the discotic liquid crystalline molecule is described in Japanese Patent Application Laid-Open No. 08-50206. Moreover, polymerization of the discotic liquid crystalline molecule is described in Japanese Patent Application Laid-Open No. 08-27284.

In order to fix the discotic liquid crystalline molecule by polymerization, it is necessary to bond a polymerizable group to a discotic core of the discotic liquid crystalline molecule as a substituent. A compound in which the discotic core and the polymerizable group are bonded through a linking group is preferable. Thereby, the oriented state can be kept also in the polymerization reaction. For example, a compound described in paragraph numbers [0151] to [0168] of Japanese Patent Application Laid-Open No. 2000-155216, and the like are included.

In hybrid orientation, an angle made by a long axis (disk plane) of the discotic liquid crystalline molecule and the surface of the polarizing film increases or decreases in a depth direction of the optical anisotropy layer together with increase in a distance from the surface of the polarizing film. Preferably, the angle decreases with increase in the distance. Further, change of the angle can be continuous increase, continuous decrease, intermittent increase, intermittent decrease, change including continuous increase and continuous decrease, or intermittent change including increase and decrease. In the course of the thickness direction, the intermittent change includes a region where a tilt angle does not change. The angle may increase or decrease as a whole even when the region where the angle does not change is included. Furthermore, the angle preferably changes continuously.

An average direction of the long axis of the discotic liquid crystalline molecule on the polarizing film side can be usually adjusted by selecting a material of the discotic liquid crystalline molecule or the oriented film or selecting the rubbing treatment method. Moreover, the long axis (disk plane) direction of the discotic liquid crystalline molecule on the surface side (air side) can be usually adjusted by selecting a kind of the discotic liquid crystalline molecule or an additive used with the discotic liquid crystalline molecule. Examples of the additive used with the discotic liquid crystalline molecule can include a plasticizer, a surfactant, a polymerizable monomer, a polymer, etc. A degree of change in the long axis orientation direction can be adjusted by selecting the liquid crystalline molecule and the additive in the same manner as mentioned above. “Other compositions of the optical anisotropy layer”

A plasticizer, a surfactant, a polymerizable monomer, etc. can be used together with the above-mentioned liquid crystalline molecule to improve uniformity of the coated film, strength of the film, orientation properties of the liquid crystal element, etc. Preferably, these have compatibility with the liquid crystalline molecule, and can change the tilt angle of the liquid crystalline molecule, or do not obstruct the orientation.

The polymerizable monomer includes radically polymerizable compounds or cationically polymerizable compounds. A preferable polymerizable monomer is polyfunctional radical polymerizable monomers, and the ones copolymerizable with the liquid crystal compound containing the above-mentioned polymerizable group are preferable. For example, a polymerizable monomer described in paragraph numbers [0018] to [0020] of Japanese Patent Application Laid-Open No. 2002-296423 is included. An amount of addition of the above-mentioned compound is usually within the range of 1 to 50 mass % to the discotic liquid crystalline molecule, and preferably within the range of 5 to 30 mass %.

The surfactant includes conventionally known compounds, and particularly fluorine system compounds are preferable. Specifically, a compound described in paragraph numbers [0028] to [0056] of Japanese Patent Application Laid-Open No. 2001-330725 is included, for example.

Preferably, the polymer used with the discotic liquid crystalline molecule can change the tilt angle of the discotic liquid crystalline molecule.

Examples of the polymer can include cellulose esters. Preferable examples of cellulose esters include those described in paragraph number [0178] of Japanese Patent Application Laid-Open No. 2000-155216. In order to avoid obstruction of orientation of the liquid crystalline molecule, an amount of addition of the above-mentioned polymer is preferably within the range of 0.1 to 10 mass % to the liquid crystalline molecule, and more preferably within the range of 0.1 to 8 mass %.

A discotic nematic liquid crystal phase-solid phase transition temperature of the discotic liquid crystalline molecule is preferably 70 to 300° C., and more preferably 70 to 170° C.

### [Formation of the Optical Anisotropy Layer]

The optical anisotropy layer can be formed by applying a coating liquid including the liquid crystalline molecule and, when necessary, a polymerizable initiator and arbitrary components onto the oriented film.

As a solvent used to prepare the coating liquid, an organic solvent is preferably used. Examples of the organic solvent include amides (for example, N,N-dimethylformamide), sulfoxides (for example, dimethyl sulfoxide), heterocycle compounds (for example, pyridine), hydrocarbons (for example, benzene, hexane), alkyl halides (for example, chloroform, dichloromethane, tetrachloroethane), esters (for example, methyl acetate, butyl acetate), ketones (for example, acetone, methyl ethyl ketone), and ethers (for example, tetrahydrofuran, 1,2-dimethoxyethane). Alkyl halides and ketones are preferable. Not less than two kinds of the organic solvents may be used together.

The coating liquid can be applied by a known method (for example, a wire bar coating method, a extrusion coating method, a direct gravure coating method, a reverse gravure coating method, a die coating method).

A thickness of the optical anisotropy layer thickness is preferably 0.1 to 20 μm, more preferably 0.5 to 15 μm, and still more preferably 1 to 10 μm.

### [Fixation of the Oriented State of the Liquid Crystalline Molecule]

The oriented liquid crystalline molecule can be fixed with the oriented state being maintained. Preferably, fixation is performed by a polymerization reaction. The polymerization reaction includes a thermal polymerization reaction using a thermal polymerization initiator and a photopolymerization reaction using a photopolymerization initiator. The photopolymerization reaction is preferable.

Examples of the photopolymerization initiator include a-carbonyl compounds (described in U.S. Pat. Nos. 2,367,661 and 2,367,670), acyloin ethers (described in U.S. Pat. No. 2,448,828), α-hydrocarbon substituted aromatic acyloin compounds (described in U.S. Pat. No. 2,722,512), polynuclear quinone compounds (described in U.S. Pat. Nos. 3,046,127 and 2,951,758), a combination of triarylimidazole imidazole dimer and p-aminophenyl ketone (described in U.S. Pat. No. 3,549,367), acridine and phenazine compounds (described in Japanese Patent Application Laid-Open No. 60-105667 and U.S. Pat. No. 4,239,850), and oxadiazole compounds (described in U.S. Pat. No. 4,212,970).

An amount of the photopolymerization initiator used is preferably within the range of 0.01 to 20 mass % of a solid content of the coating liquid, and more preferably within the range of 0.5 to 5 mass %.

An ultraviolet ray is preferably used for irradiation with light to polymerize the liquid crystalline molecule.

An irradiation energy is preferably within the range of 20 mJ/cm² to 50 J/cm², more preferably within the range of 20 mJ/cm² to 5000 mJ/cm², and still more preferably within the range of 100 mJ/cm² to 800 mJ/cm². In order to accelerate the photopolymerization reaction, irradiation with light may be performed under heating conditions.

A protective layer may be provided on the optical anisotropy layer.

A combination of the optical compensation film with the polarizing layer is also preferable. Specifically, the optical anisotropy layer is formed by applying the above-mentioned coating liquid for the optical anisotropy layer onto the surface of the polarizing film. As a result, a thin polarizing plate having small stress accompanied with dimension change of the polarizing film (distortion×cross-section area×modulus of elasticity) is produced without using a polymer film between the polarizing film and the optical anisotropy layer. When the polarizing plate according to the present invention is mounted on a large-sized liquid crystal display, an image having high display quality can be displayed without causing problems of light leakage and the like.

Preferably, stretching is performed so that an tilt angle of the polarizing layer and the optical compensation layer may be aligned with an angle made by a transmission axis of two polarizing plates laminated on both sides of the liquid crystal cell that configures the LCD and the lengthwise or transverse direction of the liquid crystal cell. A usual tilt angle is 45°. However, in the LCDs of a transmission type, a reflection type, and a transflective type, an apparatus whose tilt angle is not always 45° has been developed recently. Preferably, the stretching direction can be arbitrarily adjusted in accordance with design of the LCD.

### “Liquid Crystal Display Devices”

Description will be given of each liquid crystal mode in which such an optical compensation film is used.

### (TN Mode Liquid Crystal Display Device)

A TN mode liquid crystal display device is most generally used as a color TFT liquid crystal display device, and has been described in a number of documents. In the oriented state of the liquid crystal cell in black displaying in the TN mode, the rod-like liquid crystalline molecules stand up in the cell central portion while the rod-like liquid crystalline molecules lie in the vicinity of the substrate of the cell.

### (OCB Mode Liquid Crystal Display Device)

An OCB mode cell is a bend orientation mode liquid crystal cell in which the rod-like liquid crystalline molecules in an upper part of the liquid crystal cell and those in a lower part thereof are oriented in a substantially inverted direction (symmetrically). U.S. Pat. Nos. 4,583,825 and 5,410,422 respectively have disclosed a liquid crystal display apparatus using the bend orientation mode liquid crystal cell. Because the rod-like liquid crystalline molecules are oriented symmetrically in the upper portion and lower part of the liquid crystal cell, the bend orientation mode liquid crystal cell has self optical compensation function. For that reason, this liquid crystal mode is also called an OCB (Optically Compensatory Bend) liquid crystal mode.

Similarly to the case of the TN mode, in black displaying, the OCB mode liquid crystal cell also has the oriented state of the liquid crystal cell where the rod-like liquid crystalline molecules stand up in the cell central portion while the rod-like liquid crystalline molecules lie in the vicinity of the substrate of the cell.

### (VA Mode Liquid Crystal Display Device)

As a characteristic of a VA mode liquid crystal display device, the rod-like liquid crystalline molecules are oriented substantially vertically when no voltage is applied. The VA mode liquid crystal cell includes: (1) a VA mode liquid crystal cell in a narrow sense in which the rod-like liquid crystalline molecules are oriented substantially vertically when no voltage is applied, and oriented substantially horizontally when a voltage is applied (described in Japanese Patent Application Laid-Open No. 02-176625); (2) a (MVA mode) liquid crystal cell having a multi-domain VA mode for a wider viewing angle (described in SID97, Digest of tech. Papers (Proceedings) 28 (1997) 845); (3) an (n-ASM mode) liquid crystal cell in which the rod-like liquid crystalline molecules are oriented substantially vertically when no voltage is applied, the rod-like liquid crystalline molecules are subjected to twisted multi-domain orientation when a voltage is applied (Proceedings 58 to 59 (1998), Symposium, Japanese Liquid Crystal Society); and (4) a SURVAIVAL mode liquid crystal cell (reported in LCD international 98).

### (IPS Mode Liquid Crystal Display Device)

As characteristics of an IPS mode liquid crystal display device, the rod-like liquid crystalline molecules are oriented substantially horizontal to an in-plane when no voltage is applied, and switched by changing the orientation direction of the rod-like liquid crystalline molecules depending on whether the voltage is applied. Specifically, the liquid crystal display devices described in Japanese Patent Application Laid-Open Nos. 2004-365941, 2004-12731, 2004-215620, 2002-221726, 2002-55341, and 2003-195333 can be used.

### (Other Liquid Crystal Display Devices)

Optical compensation using the same idea as that mentioned above is allowed for an ECB mode, an STN (Supper Twisted Nematic) mode, an FLC (Ferroelectric Liquid Crystal) mode, an AFLC (Anti-ferroelectric Liquid Crystal) mode, and an ASM (Axially Symmetric Aligned Microcell) mode. Additionally, these modes are effective in any liquid crystal display device of the transmission type, the reflection type, and the transflective type. These are also advantageously used as an optical compensation sheet for a GH (Guest-Host) type reflective liquid crystal display device.

Application of these detailed cellulose derivative films described above is described in detail on pages 45 to 59 of Japan Institute of Invention and Innovation, (Kokai Giho Ko-Gi No. 2001-1745, published on Mar. 15, 2001 by the Japan Institution of Invention and Innovation).

### “Provision of the Antireflection Layer (Antireflection Film)”

The antireflection film is usually formed by providing a low refractive index layer that is also a protection layer against dirt, and at least one layer having a refractive index higher than that of the low refractive index layer (namely, a high refractive index layer or a middle refractive-index layer) on a transparent substrate.

A method for forming a multi-layered film obtained by laminating transparent thin films made of an inorganic compound (metal oxides, etc.) and each having a different refractive index includes: a chemical vapor deposition (CVD) method, a physical vapor depositing (PVD) method, and a method in which a colloidal coating of metallic oxide particles is formed by a sol-gel process performed on a metallic compound such as metal alkoxides, and then, subjected to post-treatment(ultraviolet light irradiation: Japanese Patent Application Laid-Open No. 09-157855, plasma treatment: Japanese Patent Application Laid-Open No. 2002-327310) to form a thin film.

On the other hand, as an antireflection film having higher productivity, various kinds of antireflection films formed by laminating and applying thin layers obtained by dispersing inorganic particles into a matrix have been proposed.

Another type of the antireflection film is included, in which an antireflection layer given anti-glare properties and having a form of fine projections and depressions on the top layer surface is formed in the antireflection film applied as mentioned.

The cellulose acylate film of the present invention can be used as the antireflection films formed by any of the above-mentioned methods. However, a method by application (applied type) is particularly preferable.

### [A Configuration of Layers of an Applied Type Antireflection Film]

An antireflection having a configuration of layers of at least a middle refractive index layer, a high refractive index layer, and a low refractive index layer (outermost layer) in order formed on a base is designed so as to have a refractive index satisfying the following relationship.

Refractive index of high refractive index layer>refractive index of middle refractive index layer>refractive index of transparent base>refractive index of low refractive index layer

A hard-coat layer may be provided between the transparent base and the middle refractive index layer.

Further, the antireflective film may be formed of a middle refractive index hard-coat layer, the high refractive index layer, and the low refractive index layer.

For example, the antireflective films include: those described in Japanese Patent Application Laid-Open Nos. 8-122504, 8-110401, 10-300902, 2002-243906 and 2000-111706. Moreover, other functions may be added to each layer. For example, the antireflection film including a low refractive index layer having protection properties against dirt and a high refractive index layer having antistatic properties (for example, Japanese Patent Application Laid-Open Nos. 10-206603, 2002-243906, etc.) is included.

A haze of the antireflection film is preferably not more than 5%, and more preferably not more than 3%. Moreover, strength of the film is preferably not less than H in a pencil hardness test in accordance with JIS K5400, and more preferably not less than 2H, and most preferably not less than 3H.

### [High Refractive Index Layer and Middle Refractive Index Layer]

A layer having a high refractive index in the antireflection film is made of a curable film that contains at least ultrafine particles of a high refractive index inorganic compound having an average particle size of not more than 100 nm and a matrix binder.

The particulates of the high refractive index inorganic compound include inorganic compounds having a refractive index of not less than 1.65, and more preferably an refractive index of not less than 1.9. For example, oxides of Ti, Zn, Sb, Sn, Zr, Ce, Ta, La, In, etc. and composite oxides including these metal atoms, etc. are included.

Methods for obtaining such ultrafine particles include: treatment of the surface of the particles by surface treating agent (for example, a silane coupling agent or the like, Japanese Patent Application Laid-Open Nos. 11-295503, 11-153703, 2000-9908, an anionic compound or organic metal coupling agent, Japanese Patent Application Laid-Open No. 2001-310432 etc.); formation of a core shell structure by using a high refractive index particle as a core (Japanese Patent Application Laid-Open No. 2001-166104 etc.); and use with a particular dispersant (Japanese Patent Application Laid-Open No. 11-153703, U.S. Pat. No. 6,210,858B1, Japanese Patent Application Laid-Open No. 2002-2776069, etc.).

Materials for forming the matrix include conventionally known thermoplastic resins, curable resin membranes, etc.

Furthermore, at least one composition is preferable, which is selected from: a composition including a polyfunctional compound that contains at least not less than two polymerizable groups radically polymerizable and/or cationically polymerizable, an organometallic compound containing a hydrolytic group, and a composition of the partially condensed product of the organometallic compound. For example, compounds described in Japanese Patent Application Laid-Open Nos. 2000-47004, 2001-315242, 2001-31871 and 2001-296401 are included.

Moreover, a curable film obtained from a colloidal metal oxide obtained by hydrolysis condensate of a metal alkoxide and a metal alkoxide composition is also preferable. For example, such a curable film is described in Japanese Patent Application Laid-Open No. 2001-293818, etc.

A refractive index of the high refractive index layer is usually 1.70 to 2.20. A thickness of the high refractive index layer is preferably 5 nm to 10 and more preferably 10 nm to 1 μm.

The refractive index of the middle refractive index layer is adjusted so as to be a value between the refractive index of the low refractive index layer and the refractive index of the high refractive index layer. The refractive index of the middle refractive index layer is preferably 1.50 to 1.70.

### [Low Refractive Index Layer]

The low refractive index layer is formed by sequentially laminating on the high refractive index layer. The refractive index of the low refractive index layer is 1.20 to 1.55. A preferable refractive index thereof is 1.30 to 1.50.

Preferably, the low refractive index layer is formed as the outermost layer having abrasion resistance and protection properties against dirt. As measures to significantly improve abrasion resistance, assignment of slip properties to the surface is effective. Conventionally known measures, such as a thin film layer formed by introduction of silicone, introduction of fluorine, etc., can be used.

The refractive index of a fluorine-containing compound is preferably 1.35 to 1.50. More preferably, it is 1.36 to 1.47. Moreover, the fluorine-containing compound is preferably a compound including fluorine atoms in the range of 35 to 80 mass % and including a crosslinkable or polymerizable functional group.

For example, compounds described in paragraph numbers [0018] to [0026] of Japanese Patent Application Laid-Open No. 9-222503, paragraph numbers [0019] to [0030] of Japanese Patent Application Laid-Open No. 11-38202, paragraph numbers [0027] to [0028] of Japanese Patent Application Laid-Open No. 2001-40284, Japanese Patent Application Laid-Open No. 2000-284102, etc. are included.

Preferably, the silicone compound is a compound having a polysiloxane structure, contains a curable functional group or a polymerizable functional group in a polymer chain, and has a crosslinked structure in the film. For example, reactive silicone (for example, Silaplane (made by Chisso Corporation, etc.)), polysiloxane containing a silanol group in both ends (Japanese Patent Application Laid-Open No. 11-258403, etc.), etc. are included.

Preferably, a crosslinking or polymerization reaction of a fluorine-containing polymer and/or a siloxane polymer having a crosslinking or polymerizable group is performed by irradiation with light or heating simultaneously with or after applying a coating composition for forming the outermost layer, the coating composition containing a polymerization initiator, a sensitizer, etc.

A sol-gel cured layer is also preferable, which is obtained by curing an organometallic compound such as a silane coupling agent and a silane coupling agent containing a particular fluorine-containing hydrocarbon group by a condensation reaction in presence of a catalyst.

Examples of the sol-gel cured layer include: polyfluoroalkyl-group-containing silane compounds or the partially hydrolyzed and condensed compounds thereof (compounds described in Japanese Patent Application Laid-Open Nos. 58-142958, 58-147483, 58-147484, 09-157582 and 11-106704); and silyl compounds that contain a “poly(perfluoroalkyl ether)” group as a fluoline-containing long-chain group (compounds described in Japanese Patent Application Laid-Open Nos. 2000-117902, 2001-48590, and 2002-53804).

The low refractive index layer can contain a filler, (for example, a low refractive index inorganic compound having a primary particle mean diameter of 1 to 150 nm, such as silicon dioxide (silica) and fluorine-containing particles (magnesium fluoride, calcium fluoride, barium fluoride) etc., organic particulates described in paragraph numbers [0020] to [0038] of Japanese Patent Application Laid-Open No. 11-3820, etc.), silane coupling agent, a sliding agent, a surfactant, etc. as additives other than the ones mentioned above.

When the low refractive index layer is located as a lower outermost layer, the low refractive index layer may be formed by a vapor phase method (a vacuum evaporation method, a spattering method, an ion-plating method, a plasma CVD method, etc.). A coating method is preferable because manufacturing cost is inexpensive.

A thickness of the low refractive index layer is preferably 30 to 200 nm, more preferably 50 to 150 nm, and most preferably 60 to 120 nm.

### [Hard-coat Layer]

The hard-coat layer is provided on the surface of the stretched or unstretched cellulose acylate film in order to give physical strength to the antireflection film.

Particularly preferably, the hard-coat layer is provided between the stretched or unstretched cellulose acylate film and the high refractive index layer. It is also preferable that the hard-coat layer is directly applied onto the stretched or unstretched cellulose acylate film without providing the antireflection layer.

The hard-coat layer is preferably formed by a crosslinking reaction or a polymerization reaction of a compound curable by light and/or heat.

As a curable functional group, photopolymerizable functional groups are preferable. As an organometallic compound containing a hydrolytic functional group, organic alkoxysilyl compounds are preferable.

Examples of these compounds include the same compounds as those exemplified in the case of the high refractive index layer.

A specific configuration composition of the hard-coat layer includes those described in Japanese Patent Application Laid-Open Nos. 2002-144913 and 2000-9908, and WO 00/46617, for example.

The high refractive index layer can serve also as the hard-coat layer. In such a case, preferably, the hard-coat layer is formed by minutely dispersing particulates obtained by using the method described in the case of the high refractive index layer to contain the particulates in the hard-coat layer.

The hard-coat layer can serve also as the anti-glare layer (mentioned later) in which particles having an average particle size of 0.2 to 10 μm is contained and anti-glare function (anti-glare function) is given.

A thickness of the hard-coat layer can be appropriately designed according to application. The thickness of the hard-coat layer is preferably 0.2 to 10 μm, and more preferably 0.5 to 7 μm.

In the pencil hardness test in accordance with JIS K5400, strength of the hard-coat layer is preferably not less than H, more preferably not less than 2H, and most preferably not less than 3H. Moreover, in a Taber test in accordance with JIS K5400, a smaller amount of wear of a test piece before and after the test is more preferable.

### [Forward Scattering Layer]

A forward scattering layer is provided in order to give an effect of improving the viewing angle when an visual angle is inclined in four directions of upward, downward, left, and right directions in application to the liquid crystal display. The forward scattering layer can have also the hard-coat function when particulates having different refractive indexes are dispersed in the above-mentioned hard-coat layer.

The forward scattering layer includes: those described in Japanese Patent Application Laid-Open No. 11-38208 where a coefficient of forward scattering is specified; those described in Japanese Patent Application Laid-Open No. 2000-199809 where the relative refractive index of a transparent resin and fine particles are within a specified range; and those described in Japanese Patent Application Laid-Open No. 2002-107512 wherein a haze value of not less than 40% is specified.

### [Other Layers]

In addition to the above-mentioned layers, a primer layer, an antistatic layer, an undercoat layer, a protective layer, etc. may be provided.

### [Coating Method]

Each layer of the antireflection film can be formed by coating using a dip coating method, an air knife coat method, a curtain coat method, a roller coat method, a wire bar coat method, a gravure coating method, a micro gravure method, and an extrusion coat method (U.S. Pat. No. 2,681,294).

### [Anti-glare Function]

The antireflection film may have anti-glare function to scatter external light. The anti-glare function is obtained by forming projections and depressions on the surface of the antireflection film. When the antireflection film has the anti-glare function, a haze of the antireflection film is preferably 3 to 30%, more preferably 5 to 20%, and most preferably 7 to 20%.

Any method can be used as a method for forming the projections and depressions on the surface of the antireflection film as long as the shape formed on the surface can be held fully. For example, such a method includes a method for forming projections and depressions on a film surface of the low refractive index layer using particulates (for example, Japanese Patent Application Laid-Open No. 2000-271878, etc.); a method for adding a small amount (0.1 to 50 mass %) of relatively large particles (particle size of 0.05 to 2 μm) to form a film having surface unevenness in a lower layer of a low refractive index layer (a high refractive index layer, a middle refractive index layer, or a hard-coat layer), and maintaining these shapes to provide the low refractive index layer on the lower layer (for example, Japanese Patent Application Laid-Open Nos. 2000-281410, 2000-95893, 2001-100004, 2001-281407); a method for physically transferring a shape of projections and depressions on the surface after coating a top layer (a protection layer against dirt) (for example, embossing described in Japanese Patent Application Laid-Open Nos. 63-278839, 11-183710, 2000-275401), etc.

### [Application]

The unstretched or stretched cellulose acylate film of the present invention are useful as an optical film, especially a film for protecting a polarizing plate, an optical compensation sheet for the liquid crystal display (hereinafter, referred to as a retardation film), an optical compensation sheet for a reflective liquid crystal display device, and a support for a photosensitive material of silver halide.

Hereinafter, the methods of measurement used in the present invention will be described.

### (1) Modulus of Elasticity

The modulus of elasticity was determined in a 23° C. and 70% rh atmosphere by measuring stress at 0.5% of elongation at a tension velocity of 10%/min. Measurement in MD and TD was performed, and this average value was determined as the modulus of elasticity.

### (2) The Degree of Substitution of Cellulose Acylate

The degree of substitution of each acyl group in cellulose acylate and the degree of substitution thereof at 6-position was determined using 13C-NMR by the method described Carbohydr. Res. 273 (1995), 83-91 (by Tezuka, et al).

### (3) Residual Solvent

A mixture obtained by dissolving 300 mg of a sample film into 30 ml of methyl acetate (Sample A) and a mixture obtained by dissolving 300 mg of a sample film into 30 ml of dichloromethane (Sample B) were produced.

These were measured under the following conditions using gas chromatography (GC).

Column: DB-WAX (0.25 mmφ×30 m, a thickness of 0.25 μm)

Column temperature: 50° C.

Carrier gas: nitrogen

Analyzing time: 15 minutes

Amount of an injected sample: 1 μml

An amount of the solvent was determined by the method below.

In Sample A, using a calibration curve, a content of each peak other than that of the solvent (methyl acetate) is determined, and the total is defined as Sa.

In Sample B, a content is determined using a calibration curve of each peak in the region hidden by the peak of the solvent in Sample A, and the total is defined as Sb.

The sum of Sa and Sb is an amount of the residual solvent.

### (4) Ratio of Heating Loss at 220° C.

Using a TG-DTA 2000S made by MAC Science Co., Ltd., a sample was heated under nitrogen from room temperature to a temperature of 400° C. at a temperature raising velocity of 10°/min. Weight change in 10 mg of the sample at 220° C. at this time was determined as the ratio of heating loss.

### (5) Melt Viscosity

The melt viscosity is measured under the following conditions using a viscoelasticity measuring apparatus (for example, a modular compact rheometer: Physica MCR301, made by Anton Paar GmbH) using a cone plate.

The resin is dried sufficiently so as to have the moisture content of not more than 0.1%. Subsequently, the resin is measured at a shear rate (1/second) and at a gap of 500 μm and a temperature of 220° C.

### (6) Re, Rth

Ten points were sampled at an equal interval in the width direction of a sample film. Humidity of these samples was controlled at 25° C. and 60% rh for 4 hours. Subsequently, using an automatic birefringence meter (KOBRA-21ADH: made by Oji Scientific Instruments), retardation values at a wavelength of 590 nm were measured at 25° C. and 60% RH in the vertical direction to the surface of the sample film and in directions inclined in increments of 10° from +50° to −50° with respect to the film plane normal where the axis of rotation was the slow axis. Thereby, the in-plane retardation value (Re) and the thickness-direction retardation value (Rth) were calculated.

Hereinafter, characteristics of the present invention will be described further in detail using Examples and Comparative Examples. Materials, amounts used, proportions, contents of treatment, procedures, etc. shown in Examples below can be properly changed without deviating from the spirit of the present invention. Therefore, it should not be interpreted that the scope of the present invention is limited by Examples shown below.

### Examples

Hereinafter, characteristics of the present invention will be described further in detail using Examples and Comparative Examples. Materials, amounts used, proportions, contents of treatment, procedures, etc. shown in Examples below can be properly changed without deviating from the spirit of the present invention.

### (1) Production of a Cellulose-based Resin Film

A cellulose-based resin (CAP-482-20, number average molecular weight of 70,000) was extruded by a single screw extruder (made by GM Engineering, Inc., cylinder inner diameter D: 90 mm) to produce a film of 100 μm at a temperature of 240° C. and a line velocity of 5 m/min. Both sides of the film (3% of the total width each) were trimmed immediately before take-up. Subsequently, a process of adding a thickness of 10 mm in width and 50 μm in height (knurling) was performed on the both sides. Other conditions were as follows.

### Example 1, Comparative Example 1

A molten resin discharged from a die at 240° C. was formed by a touch roll method at a line velocity of 30 m/min. to obtain a film having a film length of 200 mm. In Example 1, the molten resin was heated by a far-infrared heater that can control a temperature of the molten resin in the direction of the flow of the molten resin (hereinafter, simply referred to as the flow direction). A width of the heater was 1.2 times a width of a die lip. A heating distance of the heater with respect to the flow direction of the molten resin was 70% of a length of a sheet-like resin. On the other hand, no heater was used in Comparative Example 1.

### Examples 2 and 3

In Examples 2 and 3, the heater of Example 1 was divided into two or three in the flow direction, and the divided heaters were controlled separately in each case. Except that, the film was obtained under the same conditions as those in Example 1.

### Examples 4 and 5

In Examples 4 and 5, the heater in Example 3 was divided into two or three in the width direction, and the divided heaters were controlled separately in each case. Except that, the film was obtained under the same conditions as those in Example 1.

### Examples 6 and 7

In Examples 6 and 7, the heater in Example 2 was divided into two or three in the width direction, and the divided heaters were controlled separately in each case. Except that, the film was obtained under the same conditions as those in Example 3.

### Examples 8 to 14

In Examples 8 to 14, an extrusion temperature in Example 5 was changed into 270° C., 265° C., 255° C., 230° C., 220° C., 215° C., and 210° C., respectively. Except that, the film was obtained under the same conditions as those in Example 5.

### Examples 15 to 18, Comparative Example 2

In Examples 15 to 18 and Comparative Example 2, the heater in Example 2 was divided into four in the flow direction and into three in the width direction, and the divided heaters were controlled separately in each case. Moreover, the film length was changed into 200 mm, 100 mm, 500 mm, 900 mm, and 1000 mm, respectively. Except that, the film was obtained under the same conditions as those in Example 1.

### Examples 19 to 25

In Examples 19 to 25, the line velocity in Example 5 was changed into 3 m/min., 5 m/min., 10 m/min., 20 m/min., 40 m/min., 50 m/min., and 60 m/min. Except that, the film was obtained under the same conditions as those in Example 1.

### (2) Evaluation of the (Unstretched) Film Formed by Melting

### (i) Thickness Unevenness

Using a film thickness tester KG601B made by Anritsu Corporation or an off-line contact-type continuous thickness indicator, measurement was made when a measurement pitch was at an interval of 1 mm. Moreover, the thickness across the width of the film after trimming was measured in the width direction, while the thickness was measured across the length of 3 m in the flow direction. Here, A designated thickness unevenness not more than 1.0 μm, B designated that more than 1.0 μm and not more than 2.0 μm, C designated that more than 2.0 μm and not more than 3.0 μm, and F designated that more than 3.0 μm.

### (ii) Temperature and Viscosity (Temperature Distribution in the Flow Direction, Temperature Distribution in the Width Direction, the Highest Temperature, the Lowest Temperature, the Melt Viscosity, the Highest Viscosity)

Several places in the flow direction of flow and in the width direction were measured by an AGEMA thermovision CPA570 made by CHINO Corporation. The temperature distribution was evaluated using the maximum value. The viscosity was determined on the basis of a curve of a property determined by the viscosity and the temperature.

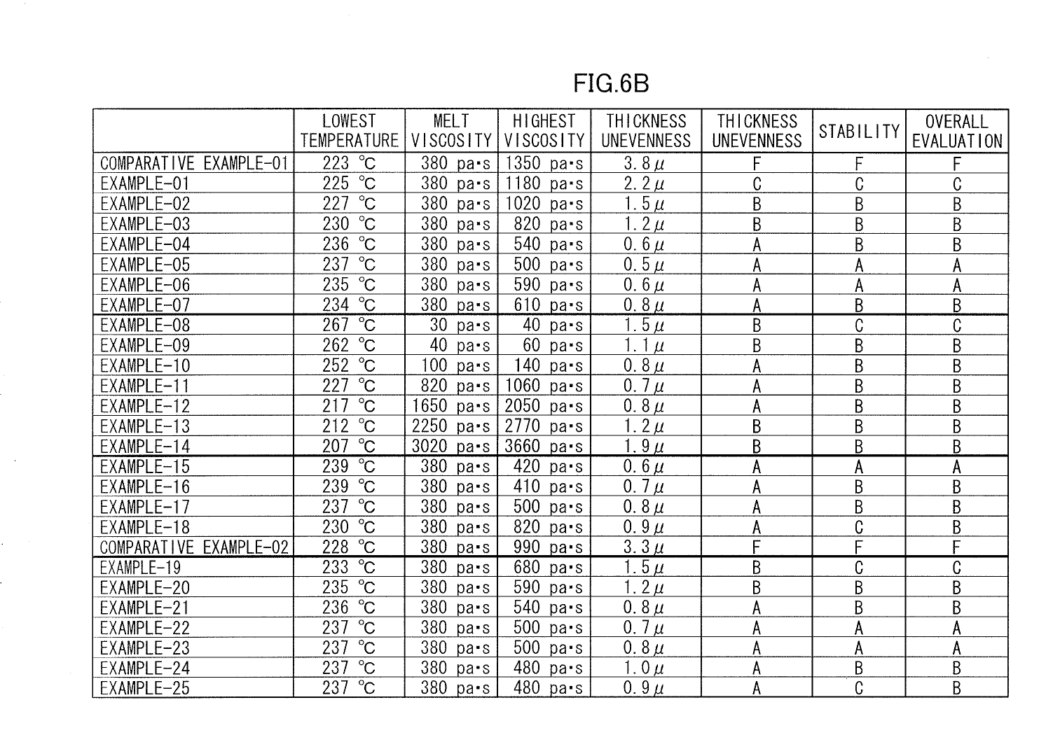

As shown in Table of FIGS. 6A and 6B, in Comparative Example 1 without a heater, the temperature distribution in the flow direction exceeded 10° C., and a poor result was obtained with respect to both of thickness unevenness and stability.

On the other hand, in Examples 1 to 25 in which the heater was provided to control the temperature distribution in the flow direction so as to be not more than 10° C., the thickness unevenness was improved significantly. Moreover, from results of Examples 1 to 7, it turned out that not less than two heaters are preferably provided in the flow direction. Further, it turned out that not less than two heaters are preferably provided also in the width directions from a viewpoint of improvement in stability.

Moreover, as shown from the results of Examples 8 to 14, the thickness unevenness and stability slightly deteriorated in Examples 8 and 9 in which the viscosity of the molten resin was less than 100 Pa·s, and in Examples 13 and 14 in which the viscosity of the molten resin was more than 2500 Pa·s. On the other hand, a film of high quality was obtained in Examples 10 to 12 in which the viscosity of the molten resin was 100 to 2500 Pa·s.

As shown from Comparative Example 2, when the film length exceeded 900 mm, it was difficult to control the temperature distribution in the flow direction so as to be not more than 10° C. As a result, a film excellent in the thickness unevenness and stability was not obtained. As in Example 18, when the film length was 900 mm, stability deteriorated. Therefore, the film length is preferably not less than 100 mm and less than 900 mm.

As shown from Examples 19 to 25, the line velocity is preferably not less than 5 m/min. and not more than 50 m/min., and more preferably not less than 20 m/min. and not more than 40 m/min.

1-6. (canceled)

7. A process for producing a thermoplastic resin film in which a molten thermoplastic resin is discharged into a sheet-like shape from a die, landed onto a rotating cooling roller, and cooled and solidified to produce a film, characterized in that
the molten resin, while the molten resin is discharged from the die and thereafter lands onto the cooling roller, is heated by a heater that can change an output in a direction of a flow of the molten resin, thereby to control temperature distribution in the direction of the flow of the molten resin within 10° C. (inclusive).

8. The process for producing a thermoplastic resin film according to claim 7, wherein the heater can change an output in a width direction of the molten resin, and control temperature distribution in the width direction of the molten resin within 10° C. (inclusive).

9. The process for producing a thermoplastic resin film according to claim 7, wherein thickness unevenness of the thermoplastic resin film after film forming is controlled so as to be not more than 1 μm.

10. The process for producing a thermoplastic resin film according to claim 8, wherein thickness unevenness of the thermoplastic resin film after film forming is controlled so as to be not more than 1 μm.

11. The process for producing a thermoplastic resin film according to claim 7, wherein the molten resin for a period of time when the molten resin is discharged from the die and lands onto the cooling roller has a melt viscosity of not less than 100 Pa·s and not more than 2500 Pa·s.

12. The process for producing a thermoplastic resin film according to claim 8, wherein the molten resin for a period of time when the molten resin is discharged from the die and lands onto the cooling roller has a melt viscosity of not less than 100 Pa·s and not more than 2500 Pa·s.

13. The process for producing a thermoplastic resin film according to claim 9, wherein the molten resin for a period of time when the molten resin is discharged from the die and lands onto the cooling roller has a melt viscosity of not less than 100 Pa·s and not more than 2500 Pa·s.

14. The process for producing a thermoplastic resin film according to claim 10, wherein the molten resin for a period of time when the molten resin is discharged from the die and lands onto the cooling roller has a melt viscosity of not less than 100 Pa·s and not more than 2500 Pa·s.

15. The process for producing a thermoplastic resin film according to claim 7, wherein the molten resin for a period of time when the molten resin is discharged from the die and lands onto the cooling roller has a length of not less than 100 mm and less than 900 mm in the direction of the flow of the molten resin.

16. The process for producing a thermoplastic resin film according to claim 8, wherein the molten resin for a period of time when the molten resin is discharged from the die and lands onto the cooling roller has a length of not less than 100 mm and less than 900 mm in the direction of the flow of the molten resin.

17. The process for producing a thermoplastic resin film according to claim 9, wherein the molten resin for a period of time when the molten resin is discharged from the die and lands onto the cooling roller has a length of not less than 100 mm and less than 900 mm in the direction of the flow of the molten resin.

18. The process for producing a thermoplastic resin film according to claim 10, wherein the molten resin for a period of time when the molten resin is discharged from the die and lands onto the cooling roller has a length of not less than 100 mm and less than 900 mm in the direction of the flow of the molten resin.

19. The process for producing a thermoplastic resin film according to claim 11, wherein the molten resin for a period of time when the molten resin is discharged from the die and lands onto the cooling roller has a length of not less than 100 mm and less than 900 mm in the direction of the flow of the molten resin.

20. The process for producing a thermoplastic resin film according to claim 12, wherein the molten resin for a period of time when the molten resin is discharged from the die and lands onto the cooling roller has a length of not less than 100 mm and less than 900 mm in the direction of the flow of the molten resin.

21. The process for producing a thermoplastic resin film according to claim 13, wherein the molten resin for a period of time when the molten resin is discharged from the die and lands onto the cooling roller has a length of not less than 100 mm and less than 900 mm in the direction of the flow of the molten resin.

22. The process for producing a thermoplastic resin film according to claim 14, wherein the molten resin for a period of time when the molten resin is discharged from the die and lands onto the cooling roller has a length of not less than 100 mm and less than 900 mm in the direction of the flow of the molten resin.

23. The process for producing a thermoplastic resin film according to claim 7, wherein the thermoplastic resin is a cellulose-based resin.

24. The process for producing a thermoplastic resin film according to claim 8, wherein the thermoplastic resin is a cellulose-based resin.

25. The process for producing a thermoplastic resin film according to claim 9, wherein the thermoplastic resin is a cellulose-based resin.

26. The process for producing a thermoplastic resin film according to claim 11, wherein the thermoplastic resin is a cellulose-based resin.

27. The process for producing a thermoplastic resin film according to claim 15, wherein the thermoplastic resin is a cellulose-based resin.
